(19) United States
(12) Patent Application Publication
(10) Pub. No.: US 2008/0294503 A1
(43) Pub. Date: Nov. 27, 2008

(54) Techniques for Displaying One or More Advertisements

(76) Inventors: Daniel M. Borislow, Palm Beach, FL (US); Gregory L. Wood, Oneonta, AL (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/126,794

(22) Filed: May 23, 2008

Related U.S. Application Data
(60) Provisional application No. 60/940,036, filed on May 24, 2007.

(51) Int. Cl. G06Q 30/00; G06Q 10/00

(52) U.S. Cl. 705/10; 705/14

(57) ABSTRACT

The invention relates to a system, device, computer readable medium, and process for displaying one or more individual advertisements based on attributes of one or more phone call related events.

### CROSS-REFERENCE TO RELATED APPLICATIONS

This application claims the benefit under 35 U.S.C. § 119(e) of U.S. Provisional Application No. 60/940,036, filed May 24, 2007, the entirety of which is incorporated herein by reference.

### BACKGROUND OF THE INVENTION

1. Field of the Invention

The invention relates to a system, device, computer readable medium, and process for displaying one or more individual advertisements based on attributes of one or more phone call related events.

2. Related Art

Currently there are a variety of alternatives to the traditional public switched telephone network (PSTN). For example, current telephone systems may use a packet switched network, which is typical in a computer data environment, rather than a circuit switched network, for a telephone connection. Rather than sending voice information through the traditional circuit-committed protocols of the PSTN, packet switched networks may rely on Voice over Internet Protocol (VoIP) implementations, which facilitate the delivery of voice information using the Internet Protocol (IP), whereby voice information is packaged in a digital form in discrete packets.

Alternatively, cellular networks enable wireless access to a telephone network by allowing a cellular phone to connect to a nearby cellular base station through an air interface. In addition to voice communications, cellular networks also allow data communications. For example, cellular phones can send and receive messages through a Short Message Service (SMS) and can retrieve and display web pages through wireless cellular links.

A Digital Enhanced Cordless Telecommunications (DECT) system is designed for short-range use as a way of implementing residential and business cordless phone communications. DECT terminals can work with DECT systems which may be connected to the GSM infrastructure and all roaming scenarios based on SIM roaming are applicable.

These are just some examples of the alternatives now available to traditional telephones. More than ever, people are traveling for both work and leisure, are spending increasing amounts of time on a computer, again both for work and leisure, and families and friends are often far away, making telephone calls an important means to stay in touch. These needs have encouraged the advent of new telecommunication technologies that are portable, convenient, and cost efficient and have led to the development of many alternatives to the traditional land line.

This increase in options, along with more competition among traditional telephone companies, have lowered the cost of telephone calls over the past several years. Consumers of all ages, along with businesses throughout the world, rely on the telephone as an everyday part of life. Keeping the costs low is important to consumers, as is apparent from the numerous promotions and fierce competition among cellular providers, long distance providers, and VoIP providers.

Most providers of telephone service of any kind charge a monthly flat fee for the service, plus additional fees for such things as long distance calls, excess minutes, calling outside of a network, calling outside of certain time frames, and calling internationally. Consumers must worry about talking too long, or calling at the wrong time or to the wrong place. In addition, the monthly fee can be quite high.

Thus there is a need for a telephone service that can provide low cost or free calls to consumers while generating revenue from a source other than the customers.

### SUMMARY OF THE INVENTION

This invention is related to a system, device, computer readable medium, and process for displaying one or more individual advertisements based on attributes of one or more phone call related events. In accordance with one embodiment of the present invention, a client device, which may be a USB device, may be coupled to a first processor based device. In accordance with an exemplary process of the present invention, a unique client identifier is received from the client device and a database is searched to identify a first group of advertisements corresponding to one or more parameters defining the attributes of one or more phone call related events associated with the client identifier. The exemplary process also includes retrieving a second group of advertisements, wherein the second group of advertisements is selected from the first group of advertisements. The exemplary process also includes sending a third group of advertisements to a remote device, wherein the third group of advertisements is selected from the second group of advertisements. The exemplary process includes the remote device displaying one or more individual advertisements selected from the third group of advertisements.

### BRIEF DESCRIPTION OF THE DRAWINGS

FIGS. 1(a) and 1(b) illustrate processes for displaying one or more individual advertisements from the perspective of a server.

FIG. 2 illustrates an example of an embodiment of the invention.

FIG. 3 illustrates an example of another embodiment of the invention.

FIG. 4 illustrates an example of another embodiment of the invention.

FIG. 5 illustrates a sample chart of possible categories that may be used in an embodiment of the invention.

FIG. 6 illustrates a sample chart of possible parameters defining the categories shown in FIG. 5.

FIGS. 7(a) and 7(b) illustrate the application of one category to a call related event.

FIGS. 8(a) and 8(b) illustrate the application of two categories to a call related event.

FIG. 9(a) illustrates the application of three categories to a call related event.

FIG. 9(b) illustrates the application of four parameters to a call related event.

FIG. 10 illustrates the application an equation associated with advertisements to a call related event.

FIG. 11 illustrates the application an equation associated with advertisements to a call related event.

FIG. 12 illustrates the application an equation associated with advertisements to a call related event.

FIG. 13 illustrates the application an equation associated with advertisements to a call related event.

FIG. 14 illustrates the application an equation associated with advertisements to a call related event.

FIG. 15 illustrates a sample chart containing tag values.

FIG. 16 illustrates a process for displaying one or more individual advertisements according to an embodiment of the invention.

FIG. 17 depicts a network environment in which a client device of the present invention may be employed.

### DETAILED DESCRIPTION OF EMBODIMENTS OF THE INVENTION

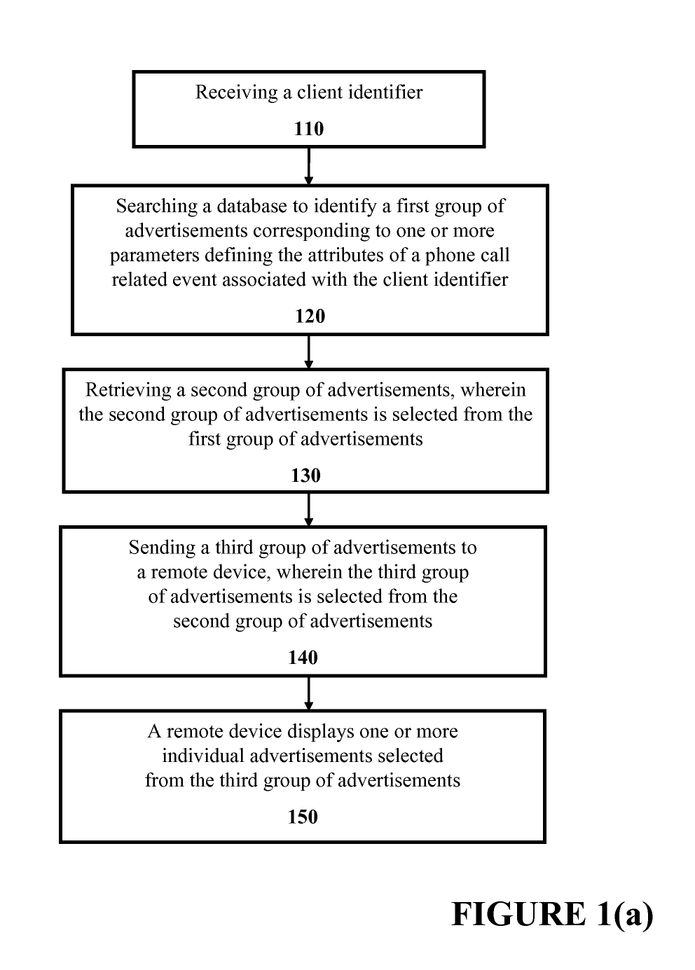

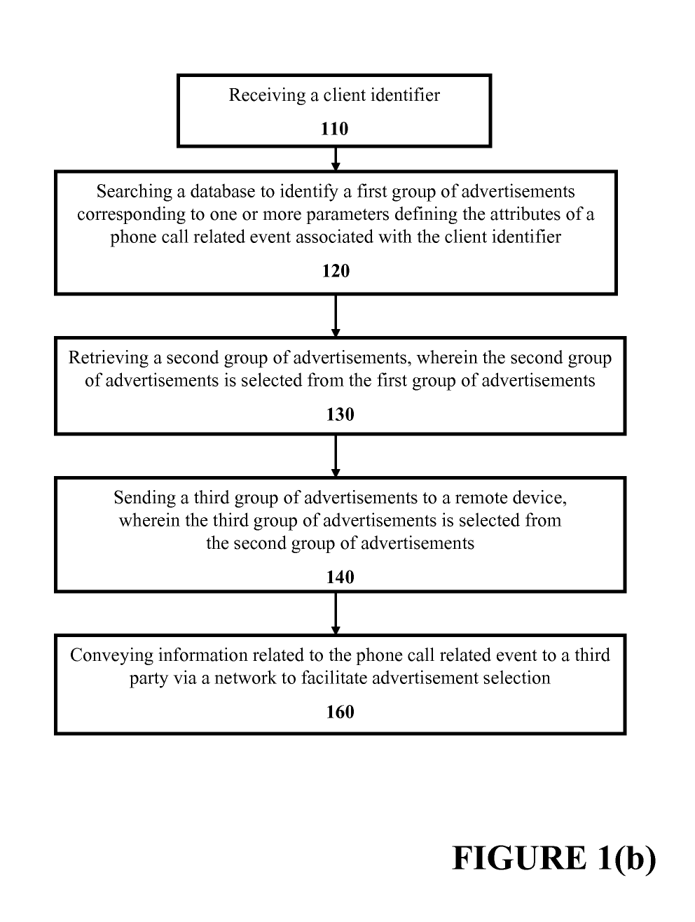

FIGS. 1(a) and 1(b) illustrate processes for displaying one or more individual advertisements from the perspective of a server.

The process includes receiving a client identifier 110. The client identifier can be any information that identifies a particular customer or client device, for example, a customer identifier, a client device serial number, a customer phone number, an Internet Protocol Address, or a media access control address. A password may also be associated with the unique client identifier. In a preferred embodiment, the unique client identifier is a client device serial number, which may or may not be coupled with a password.

In one embodiment, the client identifier is received from a client device. The client device can be any device that alone, or in combination with another device, is capable of storing and running softphone software. Examples of possible client devices include a USB device, a DECT phone, a cellular phone, and a computer. In a preferred embodiment, the client device is a USB device.

In alternative embodiments, the client identifier may be received from a first processor based device. In one embodiment, the client device comprises the first processor based device. In another embodiment, the client device is coupled to the first processor based device, which can be a computer, for example.

In one embodiment, the process may further include obtaining location identifying information associated with the client identifier. Location identifying information may be any information that associates a particular customer or client device with a particular geographic area, for example, an internet protocol address, a zip code, state, municipality, street address, latitude and longitude coordinates, global positioning system coordinates, or information defining an area based on certain market characteristics. The location identifying information may be that of the current location of the client device or the location associated with registration of the client device. In a preferred embodiment, location identifying information is latitude and longitude coordinates associated with the customer's location. In still a further embodiment, the process includes retrieving demographic information associated with the client identifier, such as age, employment status, gender, income, marital status and/or location identifying information associated with a person, from the client database.

The next step of the process includes searching a database to identify a first group of advertisements corresponding to one or more parameters defining the attributes of one or more phone call related events associated with the client identifier 120. The attributes may comprise customer proprietary network information (CPNI), such as the location of the call origination or destination, the area code of the calling or called party, the phone number exchange of the calling or called party, the phone number of the calling or called party, the time a call is made or received, the date a call is made or received, and the duration of a call. The attributes may also comprise customer proprietary network information equivalent data (CPNI equivalent data), which, as used herein, is similar information as CPNI, but the data received is not necessarily from a telecommunications company and not necessarily generated pursuant to a phone call being transmitted.

The attributes may also comprise information that may be extrapolated from the CPNI or CPNI equivalent data, such as, the category or categories of a business dialed, the name of a business dialed, the zip code, municipality, street address, latitude and longitude coordinates, global positioning system coordinates, or information defining an area based on certain market characteristics, associated with the dialing number or the number dialed.

The attributes may also include compilations of data such as the average length of phone calls made and/or received, the days of the week and/or the time of day that phone calls are made and/or received, the origination or destination of phone calls, the categories of businesses frequently dialed, or any other information obtained from compiling CPNI and/or CPNI equivalent data and extrapolations from such data.

A phone call related event can be any event associated with using a phone. In a preferred embodiment, a phone call related event comprises establishing a telephone connection. In other embodiments, a phone call related event can include entering digits into a phone book or contact list, entering digits into a phone device, or entering digits into a phone device in anticipation of establishing a telephone connection.

In a further embodiment, in the case where demographic information was retrieved, the process may further comprise searching the database to identify demographic information associated with said client identifier in addition to parameters defining the attributes of one or more phone call related events.

In a preferred embodiment, the database is a relational database. The data of the database may be stored in a memory. The memory may be accessible by a processor-based device. In the embodiment where the client identifier is received from a first processor based device, the data of the database may be stored in a memory accessible by a second processor-based device. In such an embodiment, the first processor based device may be coupled via at least one communications network to the second processor-based device. In another embodiment, the first processor-based device may be coupled via at least one data network to the second processor-based device. The data network may be a packet-switched network. Communication between the first processor-based device and the second processor-based device may be by hypertext transfer protocol. In addition, communication between said first processor-based device and said second processor-based device may be implemented via TCP/IP protocol.

The database may contain one table that includes all of the phone call related event information, or it can contain multiple tables with each table having different pieces of the phone call related event information. In one embodiment, the customer information can be input into the client database upon receipt from the client device or associated computer or when the customer dials one or more numbers of the phone.

In a further embodiment, the process includes searching the database to determine whether the customer or device associated with the unique client identifier is authorized to use the system. If the unique client identifier is not found in the database, then a message may be sent to the client device instructing it, for example, to cease operation.

In one embodiment, the first group of advertisements comprises all of the individual advertisements. In one embodiment, the first group of advertisements comprises one advertisement. In another embodiment, the first group of advertisements comprises more than one advertisement.

The process continues by retrieving a second group of advertisements, wherein the second group of advertisements is selected from the first group of advertisements 130.

In one embodiment, the second group of advertisements comprises all of the individual advertisements. In one embodiment, the second group of advertisements comprises the same individual advertisements as the first group of advertisements. In one embodiment, the second group of advertisements comprises fewer advertisements than the first group, but more than one advertisement. In another embodiment, the second group of advertisements comprises one advertisement.

In a further embodiment, in the case where demographic information was retrieved, the process may further comprise selecting the second group of advertisement from the first group of advertisements based on the demographic information associated with the client identifier.

The process continues by sending a third group of advertisements to a remote device, wherein the third group of advertisements is selected from the second group of advertisements 140.

In one embodiment, the third group of advertisements comprises all of the individual advertisements. In one embodiment, the third group of advertisements comprises the same individual advertisements as the second group of advertisements. In one embodiment, the third group of advertisements comprises the same individual advertisements as the first group of advertisements. In one embodiment, the third group of advertisements comprises fewer advertisements than the second group, but more than one advertisement. In another embodiment, the third group of advertisements comprises one advertisement.

In a further embodiment, in the case where demographic information was retrieved, the process may further comprise selecting the third group of advertisement from the second group of advertisements based on the demographic information associated with the client identifier.

Finally, the remote device displays the one or more individual advertisements selected from the third group of advertisements 150. In one embodiment, the client device is the remote device. In another embodiment, the remote device includes the client device. In another embodiment, the remote device comprises a second processor based device. In another embodiment, the third group of advertisements is sent to a remote device via a client device. In another embodiment, the remote device comprises a client device. The client device can be any device capable of displaying or facilitating the display of advertisements, for example, a USB device, a DECT phone, a cellular phone, a computer with monitor, or a set top box, such as a cable box or satellite box, coupled to a television or video screen.

In a further embodiment, in the case where demographic information was retrieved, the process may further include selecting one or more individual advertisements from the third group of advertisements based on the demographic information associated with the client identifier.

In a further embodiment of the invention, as shown in FIG. 1(b), prior to or instead of step 150, the process includes conveying information related to the phone call related event to a third party via a network to facilitate advertisement selection 160. In one embodiment, the third party is a cable television or satellite television provider. In another embodiment, the one or more advertisements are sent to a third party display. The network may be a communications network or at least one data network, such as a packet-switched network. In a preferred embodiment, the network is a packet-switched network.

As stated above, the invention includes searching a database to identify a first group of advertisements corresponding to one or more parameters defining the attributes of one or more phone call related events associated with the client identifier. An advertisement may correspond to attributes of a particular phone call related event in several ways. By way of example, an advertisement database may be set up to include one or more categories that the advertiser associated with the advertisement seeks in a phone call related event. The categories may be any categories that identify certain attributes of a phone call related event. Advertisers themselves, or the entity operating the invented system, in order to cater to the wishes of advertisers, may change the categories over time and may add new categories. In one embodiment of the invention, the system will have predefined categories from which the advertisers can choose. In a further embodiment of the invention, the advertisers may be able to define their own categories. In still a further embodiment of the invention, the advertisers may use a combination of predefined categories and categories they define on their own.

The categories may include information about a particular phone call related event (i.e., dialed an international call, dialed a number for France, dialed any number between 9 am-5 pm, answered a call between 6 pm-8 pm, called a pizza delivery service). The categories may also include information about calling patterns (i.e., made ≧50% of calls on weekends, made ≧90% of calls out of state, made ≦10% of calls to businesses, made ≧5 calls to pizza delivery businesses, etc.). In addition, the categories can also include demographic information associated with the client device (i.e., age of user, gender of user, marital status of user, income of user, etc.).

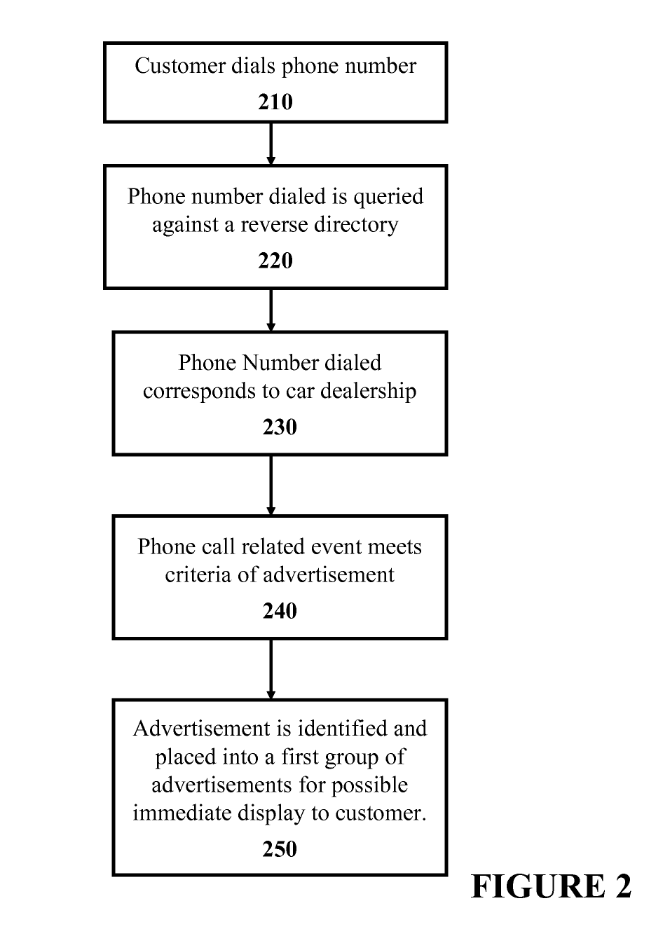

The invention includes at least three types of “matches”—(1) real-time matches, (2) delayed matches, and (3) compilation matches. Real-time matches include advertisements that are identified pursuant to the attributes of a phone call related event currently occurring. For example, while a user is conducting a phone call related event, such as placing a telephone call, the system may search a database for advertisements that correspond to attributes of that particular phone call related event. In a simple example, a car dealership may want to display an advertisement to customers who may be in the market for a new car. The dealership may choose one category, for example “CATEGORY 1=TYPE OF BUSINESS ASSOCIATED WITH PHONE NUMBER DIALED,” and stipulate that the customer must be dialing a car dealership. In this example, illustrated in FIG. 2, a customer dials the phone number 210; the phone number may be queried against a reverse-directory 220 and/or compared to a standard industry code directory; for example, and if the number dialed is that of a car dealership 230, then the phone call related event meets the criteria of the advertisement 240; and an advertisement will be identified and put into a first group of advertisements corresponding to one or more parameters defining the attributes of the phone call related event for possible immediate display to the customer 250.

Advertisers requesting real-time matches may include additional categories, such as demographic information, to further target their advertising. For example, an upscale car dealership may want to display an advertisement to a more specific audience when a customer may be in the market for a new car. The dealership may choose multiple categories, such as, for example, “CATEGORY 1=TYPE OF BUSINESS ASSOCIATED WITH PHONE NUMBER DIALED,” and stipulate that the customer must be dialing a car dealership; “CATEGORY 2=MUNICIPALITY OF CLIENT IDENTIFIER,” and stipulate that the municipality must be Washington, D.C.; CATEGORY 3=INCOME,” and stipulate that the income associated with the customer must be ≧$100,000; CATEGORY 4=AGE OF CUSTOMER,” and stipulate that the customer must be ≧30 years old. When a calling event occurs that falls into each of these categories, advertisements stipulating such criteria, such as the upscale car dealership described above, will be identified and put into a first group of advertisements corresponding to one or more parameters defining the attributes of the phone call related event for possible immediate display to the customer.

In a further example, an upscale car dealership may want to display an advertisement to a specific target audience but only during a specific time frame. If, for example, a car dealership is holding a one day special, it may want to advertise, for example, for only one week preceding the sale. In this case, the advertiser could add a category to the above categories, specifying particular dates on which to allow the advertisement to be displayed.

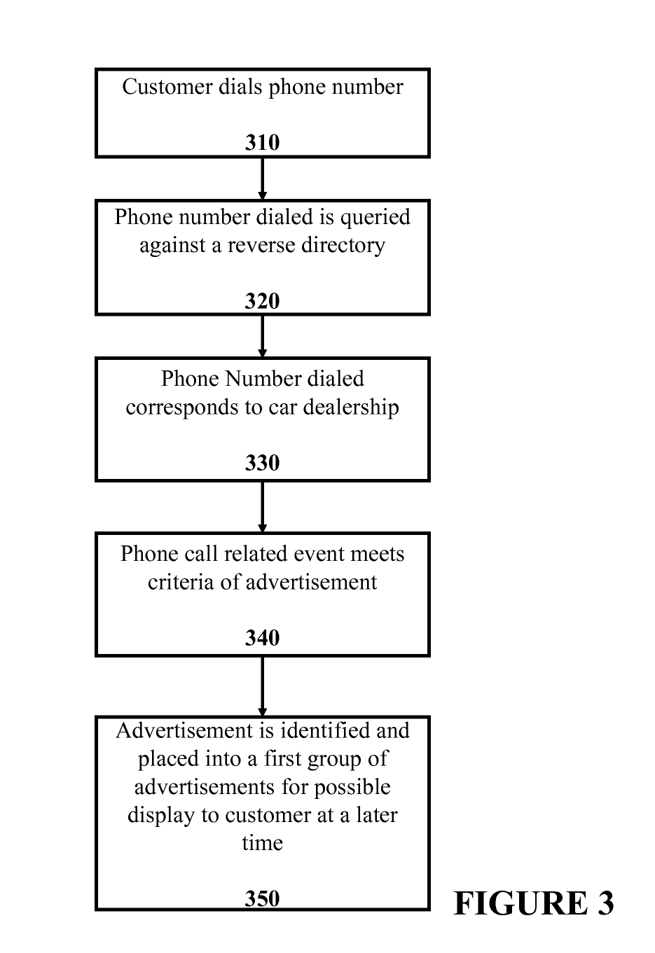

The next category of matches includes delayed matches. Delayed matches are similar to real-time matches, except that the advertisement is not displayed at the time that the phone call related event is occurring. For example, as illustrated in FIG. 3, the car dealership described above may want to display an advertisement to customers who may be in the market for a new car so, in a simple example, they may choose one category, for example “CATEGORY 1=TYPE OF BUSINESS ASSOCIATED WITH PHONE NUMBER DIALED,” and stipulate that the customer must be dialing a car dealership. Similarly to the example above, a customer dials a phone number 310; the phone number is queried against a reverse-directory 320 and/or compared to a standard industry code directory, for example, and if the number dialed is that of a car dealership 330, then the phone call related event meets the criteria of the car dealership 340. In this case, however, the advertiser is identified and placed into a first group of advertisements for possible display to a customer at a later time 350, rather than immediately. The advertiser may specify how much time should pass before the advertisement should be displayed or the advertisement may be displayed at any time within a time period specified either by the advertiser or determined by the system.

Advertisers requesting delayed matches may also include additional categories, such as demographic information, to further target their advertising. For example, the upscale car dealership described above may choose multiple categories, such as, for example, “CATEGORY 1=TYPE OF BUSINESS ASSOCIATED WITH THE PHONE NUMBER BEING DIALED,” and stipulate that the customer must be dialing a car dealership; “CATEGORY 2=MUNICIPALITY OF CLIENT IDENTIFIER,” and stipulate that the municipality must be Washington, D.C.; “CATEGORY 3=INCOME,” and stipulate that the income associated with the customer must be ≧$100,000; “CATEGORY 4=AGE OF CUSTOMER,” and stipulate that the customer must be ≧30 years old. When a calling event occurs that falls into each of these categories, advertisements stipulating such criteria, such as the upscale car dealership described above, will be identified and displayed at some time in the near future.

Like advertisers utilizing real-time matches, those utilizing delayed matches may want to display an advertisement to a specific target audience but only during a specific time frame. For example, if a car dealership is holding a one day special, it may want to advertise, for example, for only one week preceding the sale. In this case, the advertiser could add a category to the above categories, specifying particular dates on which to allow the advertisement to be displayed.

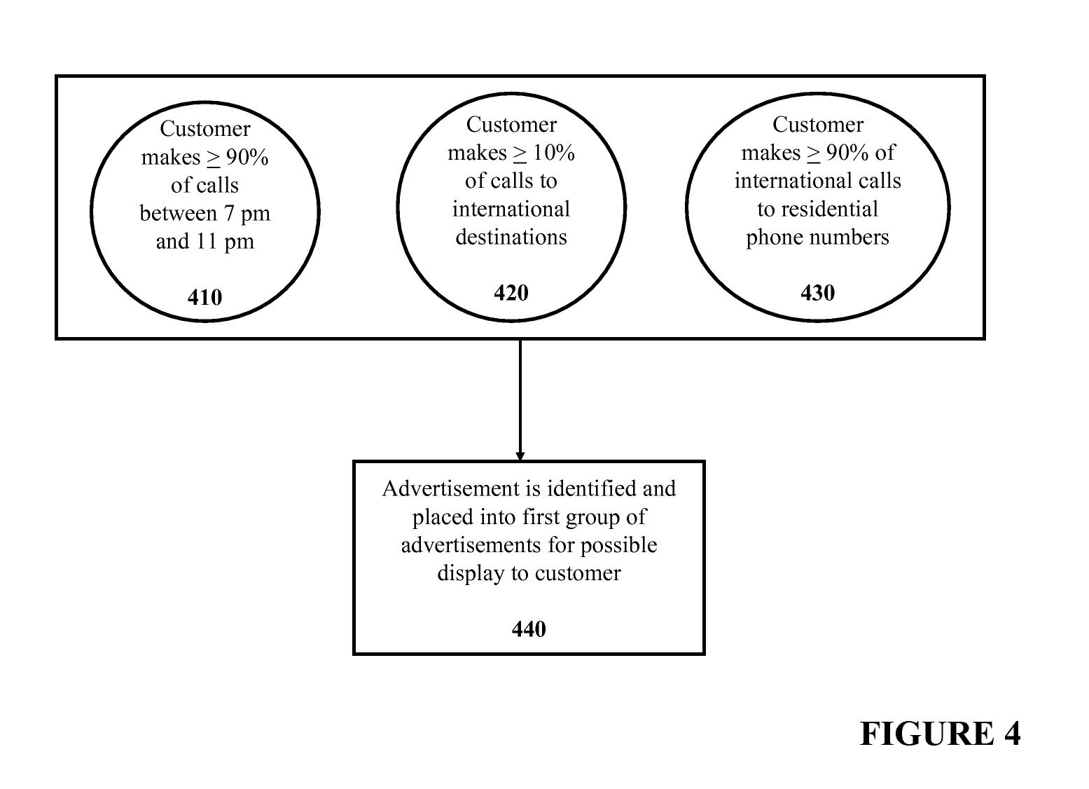

The third category of matches includes compilation matches. Compilation matches are similar to real-time and delayed matches in most respects, except the advertisements corresponding to the criteria of one or more phone call related events do not necessarily match the criteria of one specific phone call related event. Instead, in compilation matches, the categories chosen by the advertiser associated with the advertisement may be directed toward calling patterns of customers. For example, a travel agent specializing in upscale foreign travel for family reunions, may be interested in advertising to people who make most of their calls between the hours of 7 pm and 11 pm, under the assumption that such a person would be employed and working all day. In addition, they may be interested in advertising to individuals who make numerous international calls, and do so to residential phone numbers. In this example, as illustrated in FIG. 4, the categories could be, for example, “CATEGORY 1=CUSTOMER MAKES ≧90% of calls between 7 pm-11 pm” 410; “CATEGORY 2=CUSTOMER MAKES ≧10% of calls to international destinations” 420; “CATEGORY 3 CUSTOMER MAKES ≧90% of international calls to residential phone numbers” 430.

When a compilation of phone call related events meets these criteria, advertisements specifying such criteria will be identified and placed into a first group of advertisements corresponding to one or more parameters defining the attributes of the phone call related event for possible display to the customer 440. Since this is not a “real-time” search, the advertisement does not have to appear simultaneously with a particular phone call related event. In one embodiment, one or more advertisements associated with the phone call related event may appear at any time, whether or not a phone call related event is occurring. In further embodiments, the advertiser may add additional categories restricting when the advertisements may appear. For example, the advertiser may add a category requiring that any phone call related event must be occurring. In this case, the advertisement will only be displayed while the customer is making a call or inputting phone numbers or performing some other action qualifying as a phone call related event (even though the contents of that particular call may not be relevant to this particular advertisement). Alternatively, the advertisement may specify that it should only be displayed, for example, between the hours of 7 pm and 11 pm, only on weekends, or only on a particular date, whether or not a phone call related event is occurring at the time the advertisement is displayed.

Compilation matches may also include categories for demographic information. For example, the upscale travel agent described above may include categories defining a particular income or age bracket of the customer to receive the advertisement.

It may also be the case that an advertiser chooses a combination of two or more types of searches. For example, an advertiser may request a compilation match for one or more categories and also a real-time match for a specific call related event. Alternatively, an advertiser may request a compilation match for one or more categories and also a delayed match for a specific call related event. For example, the upscale travel agent described above may request compilation matches (i.e., that the customer makes at least 5 calls per month to Europe, that ≧95% of calls are between 7 pm-11 pm, and that the customer earn ≧$100,000 per year), and also require, for example, that the customer be making a call to a travel agent (in the case of a real-time match) or that the customer has made a call to a travel agent within the past 24 hours (in the case of a delayed match).

With any of the above-described types of matches or with a combination thereof, although the selection of the advertisement may be based on one or more phone call related events, the frequency with which a particular advertisement is displayed and the timing at which it is displayed may vary (unless, of course, it is a real time match, in which case it will be displayed at the time of the triggering phone call related event). For example, a particular advertiser may only wish to show a particular advertisement to each customer no more than one time per day. Another advertiser may wish to show a particular advertisement to each customer no more than one time every hour. Another advertiser may wish to show a particular advertisement to each customer no more than one time total. Yet another advertiser may wish to show a particular advertisement to each customer as frequently as possible.

The number of advertisements or the frequency at which advertisements are displayed may also vary. The system may be set to display a new advertisement at any interval that the entity operating the invented system, such as, for example, a VoIP service provider chooses. For example, in one embodiment, the system may be set to display a new advertisement every minute. In another embodiment, the system may be set to display a new advertisement every 30 seconds. In another embodiment, the system may be set to display a new advertisement every 15 minutes. In another embodiment, the intervals at which a new advertisement may be displayed may vary based on, for example, the request of an advertiser. For example, the system may be set to allow a certain advertisement (for example, if the advertiser is a preferred advertiser or pays more for this service) to remain on the screen for a longer period of time than another advertisement, thereby increasing the amount of time before the next advertisement is displayed. In addition, the advertisements may run consecutively on the screen or there may be breaks between them of uniform or varying length.

In the step of retrieving a second group of advertisements, the second group of advertisements may be the same as the first group of advertisements or it may have fewer advertisements. In one embodiment, the second group of advertisements will always be the same as the first group of advertisements because all of the advertisements selected pursuant to the searching are retrieved. In another embodiment, the second group of advertisements may be smaller because only certain advertisements from the first group are retrieved.

Likewise, in the step of sending a third group of advertisements to a remote device, the third group of advertisements may be the same as the second group of advertisements or it may have fewer advertisements. In one embodiment, the third group of advertisements will always be the same as the first group of advertisements because the all of the advertisements retrieved pursuant to the retrieving are sent to a remote device. In another embodiment, the third group of advertisements may be smaller because only certain advertisements from the second group are sent to the remote device.

There are a variety of ways in which the invention may be implemented which would be obvious to one of skill in the art. Following is an exemplary implementation that is not meant to limit the scope of the invention.

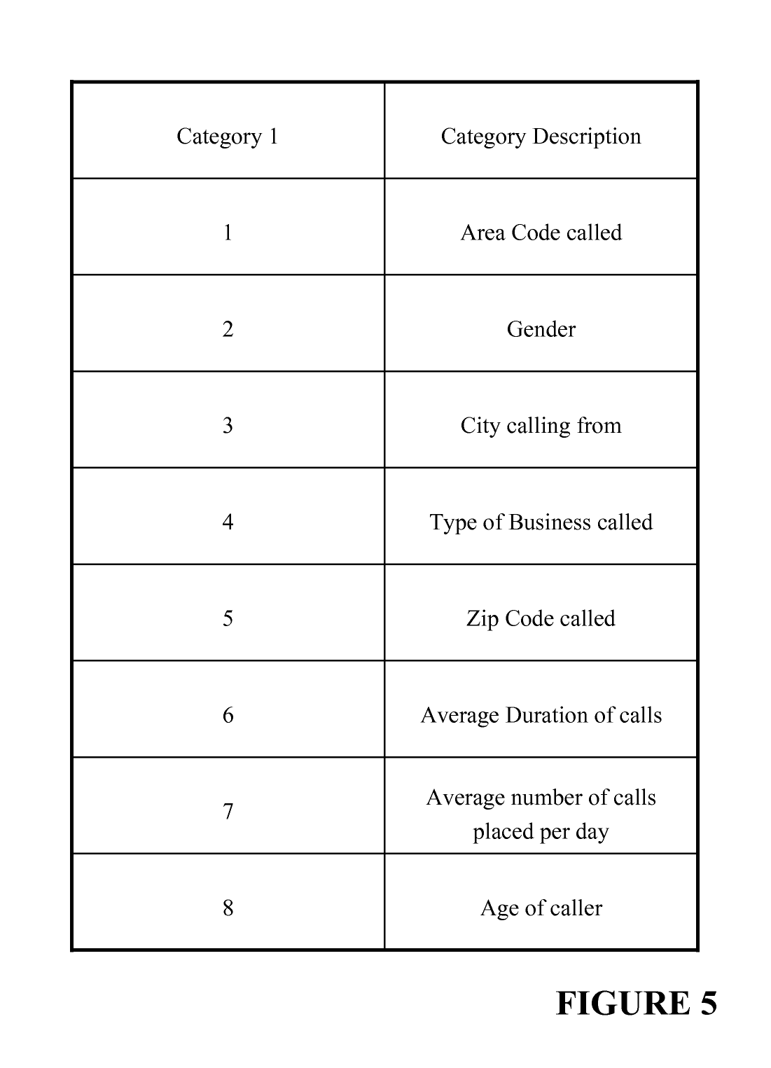

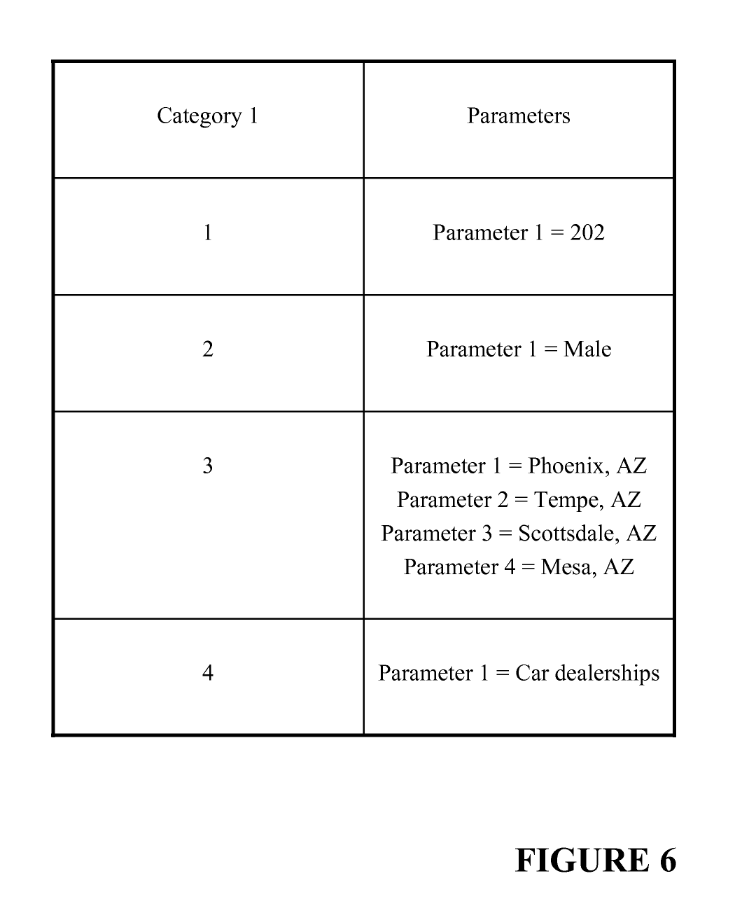

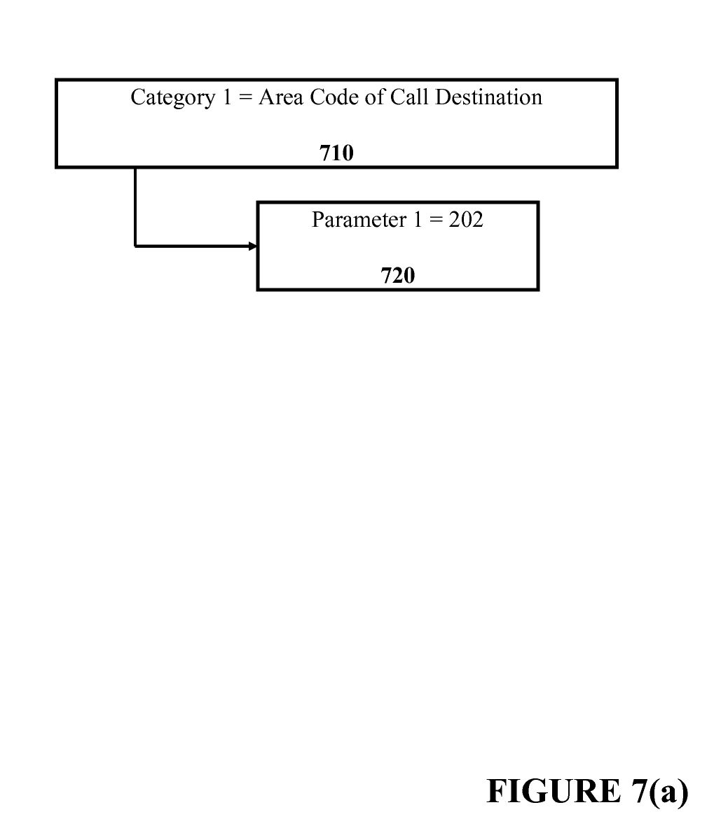

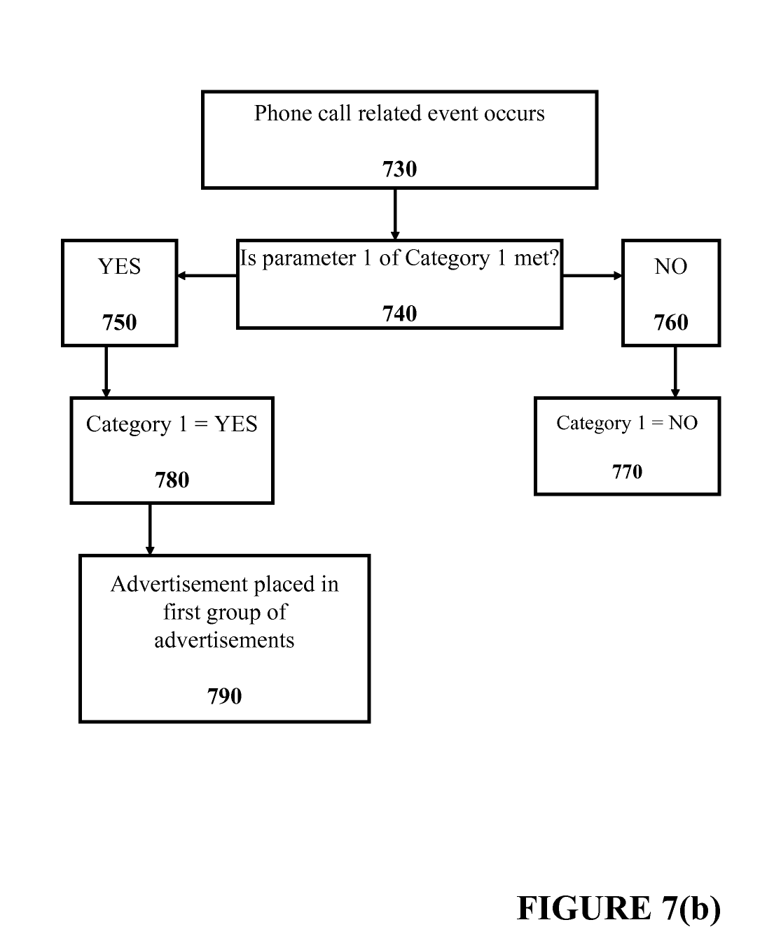

As stated above, the invention includes one or more categories. These categories may be predefined or selected by the advertiser or a combination of both. A sample chart of categories is shown in FIG. 5. Each category may, in turn, have one or more parameters defining the category as shown in FIG. 6. In a simple implementation, the parameter defining the category may have simple “YES” or “NO” answers and one “YES” of a parameter renders the category a “YES”. By way of example, as shown in FIG. 7(a), the invention may contain a category (“CATEGORY 1”) defined as “AREA CODE OF CALL DESTINATION 710.” In a simple embodiment, there may be only one parameter—Parameter 1=202 720. As shown in FIG. 7(b), if an advertiser wants to target the advertisement to customers making calls to the 202 area code, when a phone call related event occurs 730, a query is made of Parameter 1 of Category 1 740, and the system will receive a response of YES 750 or NO 760. For example, if a customer is making a call to any other area code, the system will return a response of NO 760 and CATEGORY 1 will likewise be categorized as No 770. If a customer is making a call to a number with a 202 area code, then the system will receive a YES 750 response and CATEGORY 1 will likewise be categorized as YES 780. If CATEGORY 1 is the only category stipulated by the user, then the advertisement would be placed in the first group of advertisements 790.

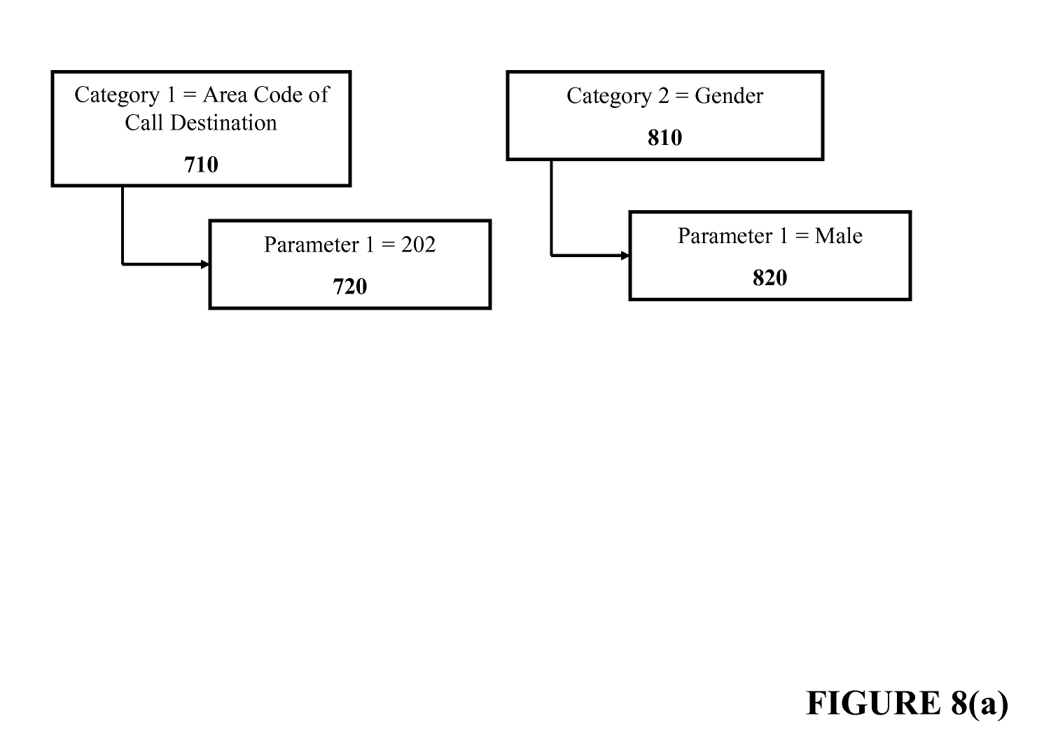

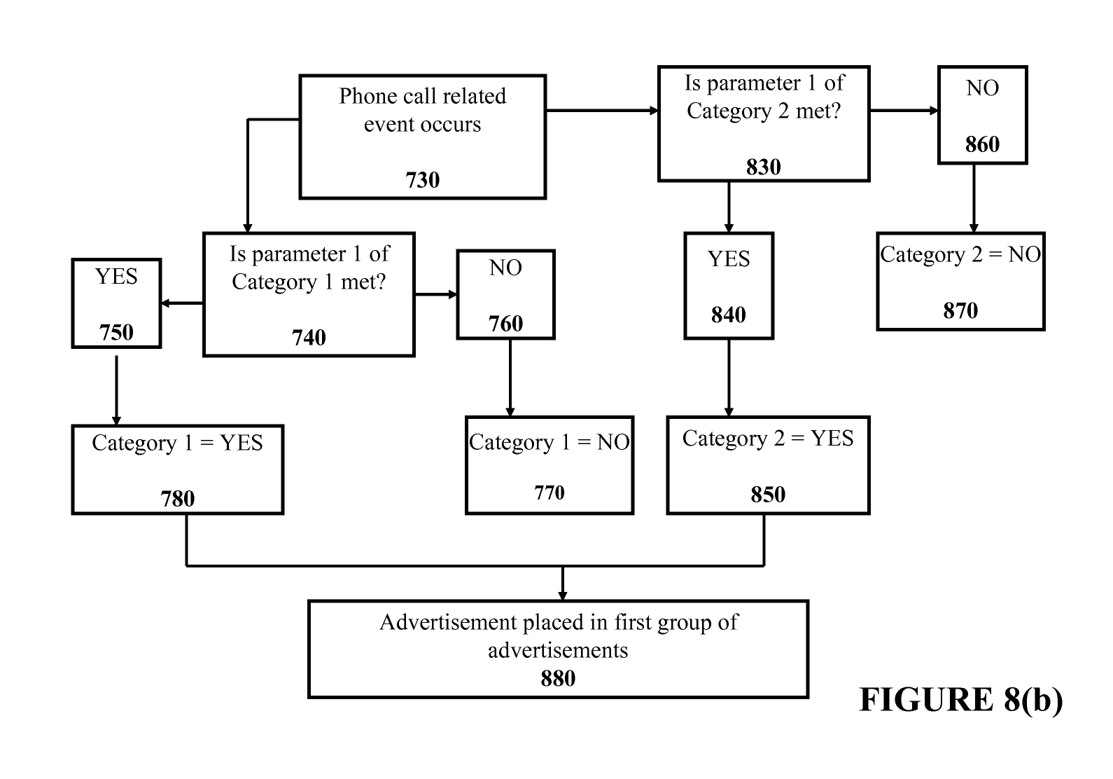

In a further example, as shown in FIG. 8(a), a second category (“CATEGORY 2”) defined as “GENDER” 810 may be stipulated. If an advertiser wants to target his advertisement to males, then CATEGORY 2 may have one parameter defining the category—Parameter 1=Male 820. As shown in FIG. 8(b), when Parameter 1 of CATEGORY 2 is queried 830, if the answer is YES 840 (indicating that the target is a male), then CATEGORY 2 will qualify to receive a YES response 850. If, on the other hand, the answer is NO 860 (indicating that the target is not a male), then CATEGORY 2 will qualify to receive a NO response 870. If the advertiser wants to further target the advertisement to males dialing the 202 area code, the system will also query the parameters of the CATEGORY 1 740. If CATEGORY 1 also returns a YES 750, then the advertisement would qualify to be placed in the first group of advertisements 880 (assuming only those two categories were stipulated).

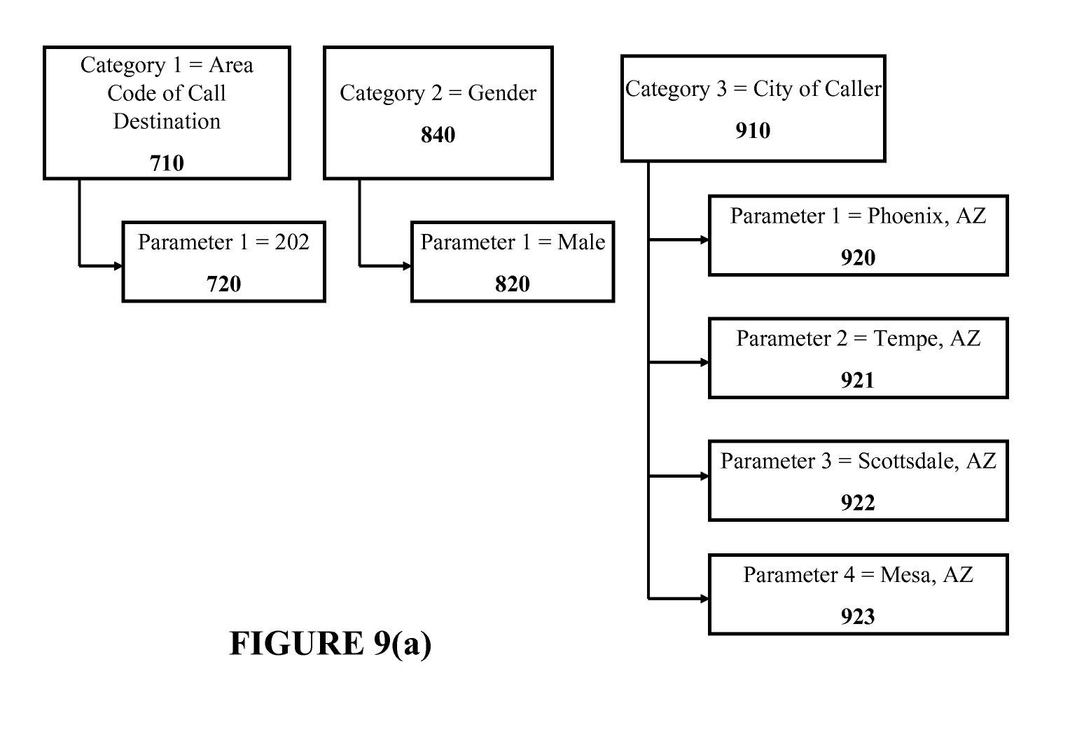

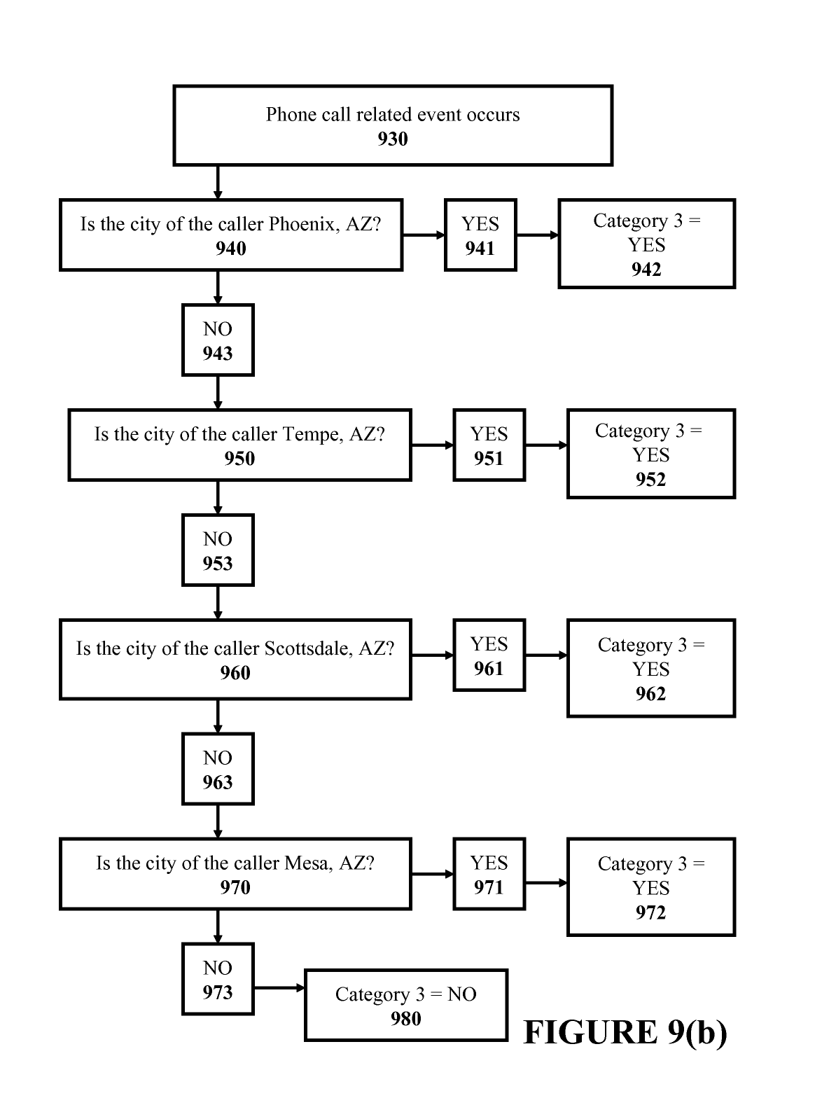

In still a further example, a third category can be stipulated by the advertiser. In this example, as shown in FIG. 9(a), the third category (“CATEGORY 3”) may be called “CITY OF CALLER” 910. CATEGORY 3 may have multiple parameters, for example—Parameter 1=Phoenix, Ariz. 920; Parameter 2=Tempe, Ariz. 921; Parameter 3=Scottsdale, Ariz. 922 and Parameter 4=Mesa, Ariz. 923. The advertiser may want to target people living in any of those Arizona cities. In this case, as shown in FIG. 9(b), each Parameter of CATEGORY 3 will be queried and if the answer is YES, then CATEGORY 3 will be designated as YES and the remainder of the Parameters will not be queried. If the answer to a Parameter Query is NO, then the next Parameter will be queried. By way of example, a phone call related event occurs 930. A query is made of Parameter 1 asking if the city of the caller is Phoenix, Ariz. 940. If the answer is YES 941, then CATEGORY 3 will be designated as YES 942, and the remainder of the parameters will not be queried. If the answer is NO 943, then Parameter 2 is queried 950. If the answer to Parameter 2 is YES 951 then CATEGORY 3 will be YES 952 and the remainder of the Parameters will not be queried. If the answer to Parameter 2 is NO 953, then Parameter 3 will be queried 960. If the answer to Parameter 3 is YES 961 then CATEGORY 3 will be YES 962 and the remainder of the Parameters will not be queried. If the answer to Parameter 3 is NO 963, then Parameter 4 will be queried 970. If the answer to Parameter 4 is YES 971, then CATEGORY 3 will be YES 972. If the answer to Parameter 4 is NO 973, then CATEGORY 3 is designated as NO (assuming there are no more parameters). In other words, only one parameter needs to be answered as a YES in order for the category to be designated as a YES. If, after the final parameter is queried (in this case, Parameter 4), all of the parameters are answered NO, then the category (in this case CATEGORY 3) will also be designated as a NO.

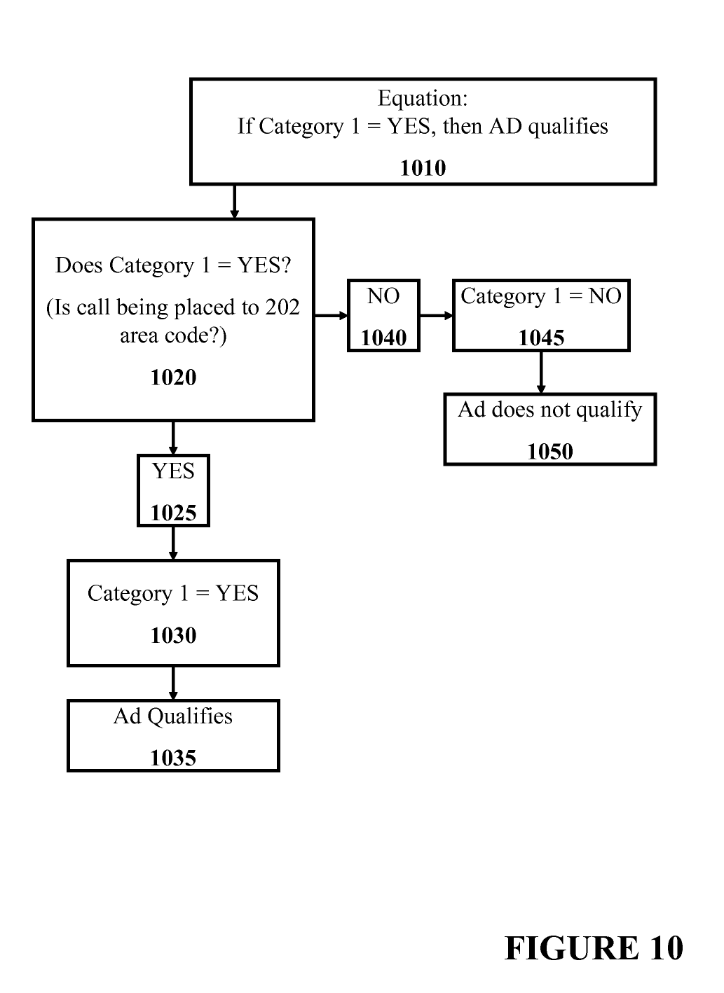

In an exemplary embodiment, the advertisements may have equations associated with them to determine whether an advertisement qualifies to be placed into the first group of advertisements. In a simple example, illustrated in FIG. 10, the equation may be “IF CATEGORY 1=YES, THEN AD QUALIFIES 1010. Using the example above, if a number is being dialed with a 202 area code, then the advertisement qualifies and will be put into group 1. This is accomplished as follows: A query is made to ask if CATEGORY 1=YES. (i.e., if the call is being placed to the 202 area code) 1020. If the answer is YES 1025, then CATEGORY 1 is YES 1030, and the Ad qualifies 1035. If the answer is NO 1040, then CATEGORY 1 is NO 1045 and the Ad does not qualify 1050.

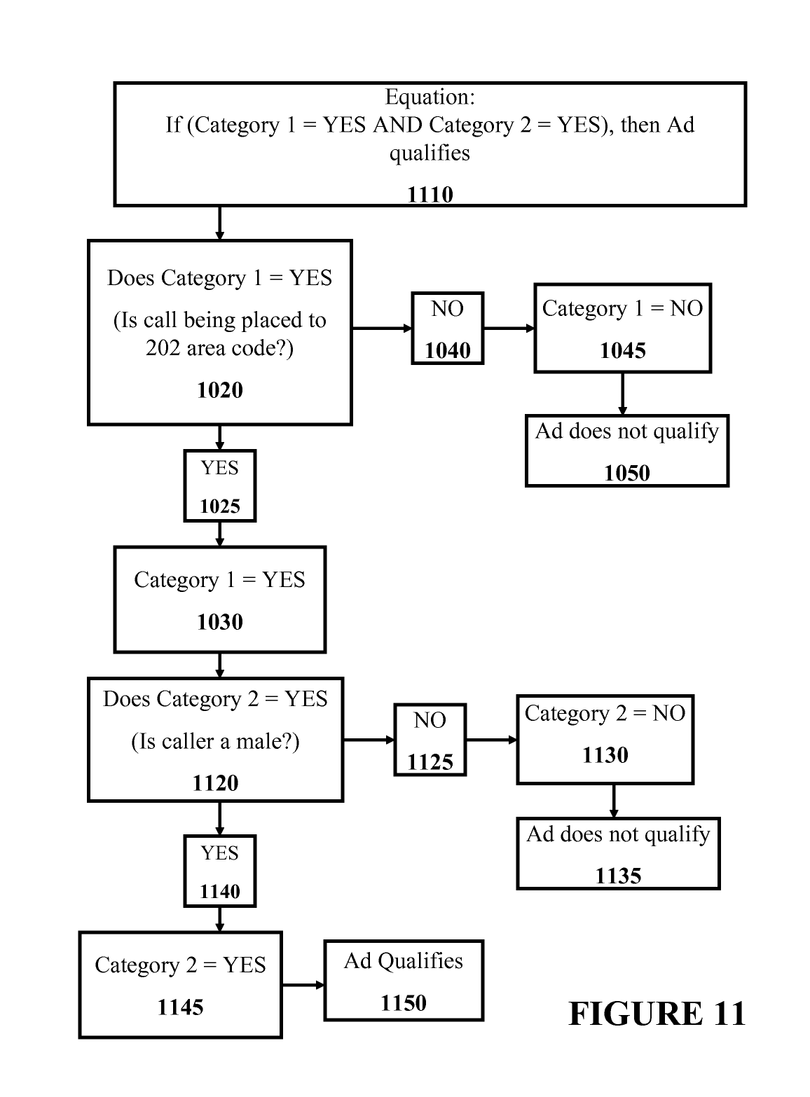

In another exemplary embodiment, as shown in FIG. 11, the equation may be, for example, IF CATEGORY 1=YES AND CATEGORY 2=YES, THEN AD QUALIFIES 1110. Again, using a previous example, if a call is being placed to the 202 area code by a male, then the advertisement qualifies and will be put into group 1. This is accomplished as follows: Queries are made according to FIG. 10. If the answer to “DOES CATEGORY 1=YES?” 1020 is YES 1025, then an additional query is made asking if Category 2=YES (i.e., asking if the call is being made by a male) 1120. If the answer is NO 1125, then Category 2=NO 1130 and the Ad does not qualify 1135. If the answer is YES 1140, then Category 2=YES 1145, and the Ad qualifies 1150.

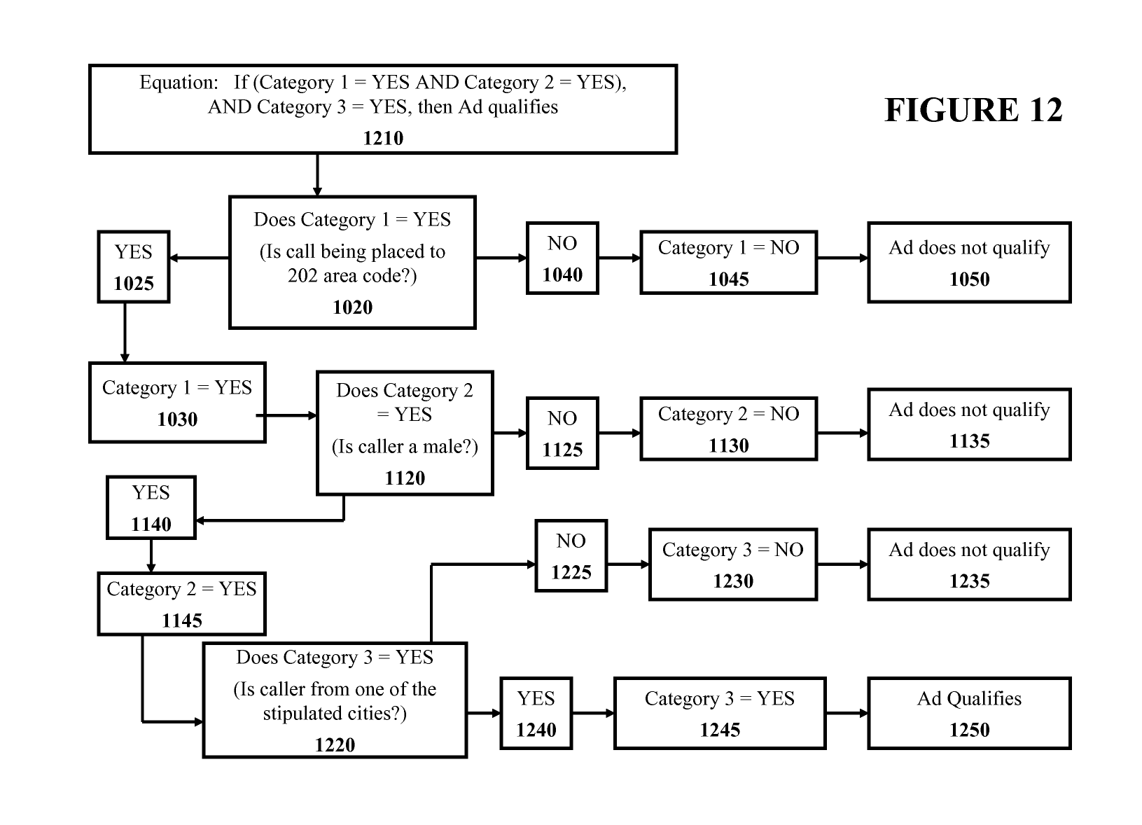

In yet another exemplary embodiment, as shown in FIG. 12, the equation may be IF CATEGORY 1=YES AND CATEGORY 2=YES AND CATEGORY 3=YES, THEN AD QUALIFIES 1210. Again, using a previous example, if a call is being placed to the 202 area code by a male, from one of the cities defined in the parameters of CATEGORY 3, then the advertisement qualifies and will be put into group 1. This is accomplished as follows: Queries are made according to FIG. 11. If the answer to “DOES CATEGORY 2=YES? 1120 is YES 1140, then an additional query is made asking if Category 3=YES (i.e., is the call being made from the stipulated cities?) 1220. If the answer is NO 1225, then Category 3=NO 1230 and the Ad does not qualify 1235. If the answer is YES 1240, then Category 3=YES 1245, and the Ad qualifies 1250.

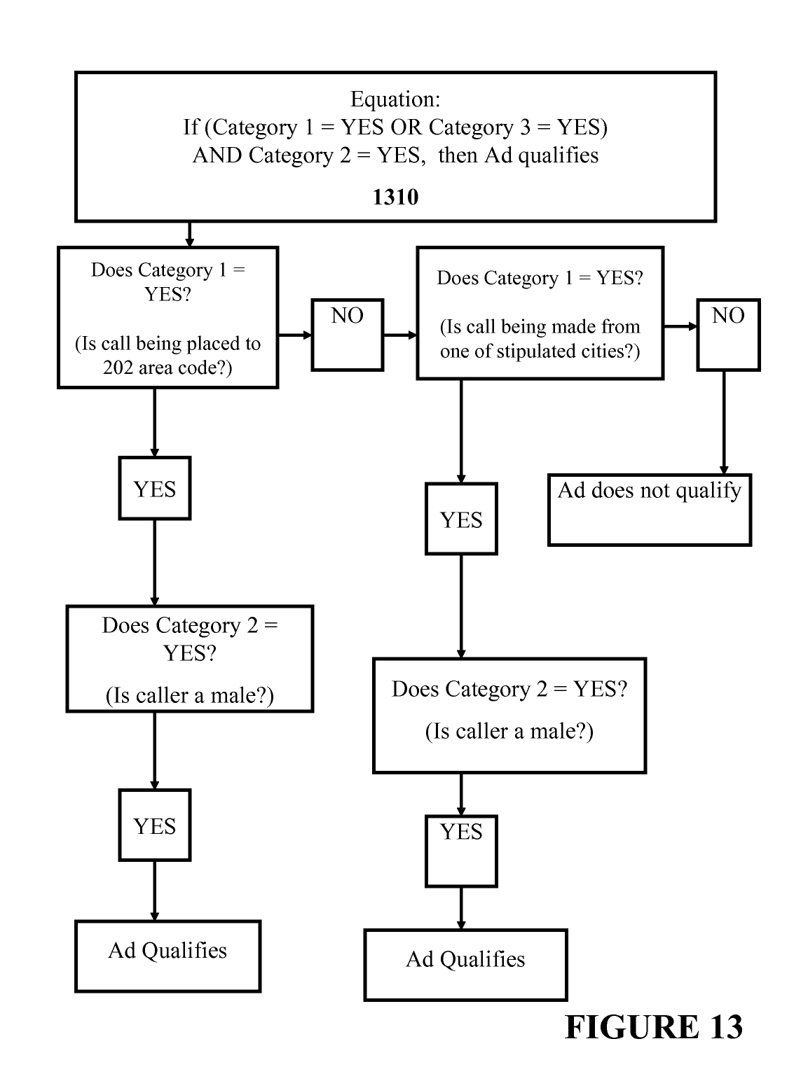

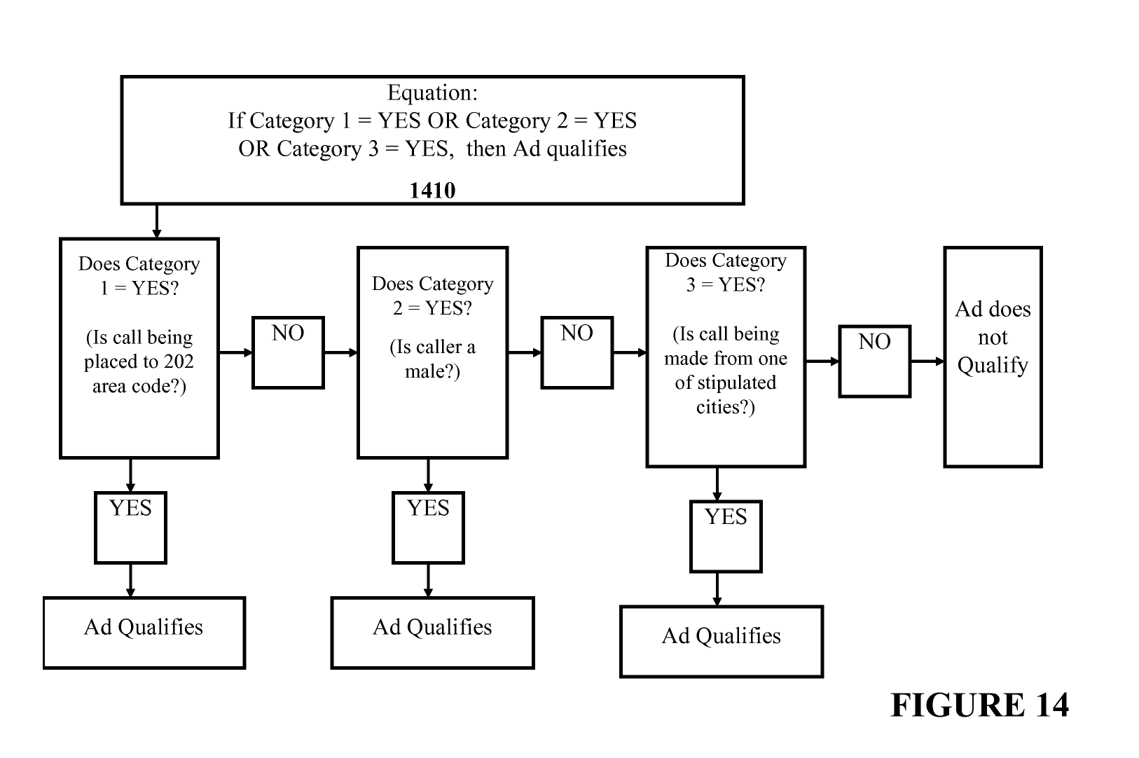

Alternatively, the equation associated with an advertisement may be more specific than simply requiring all stipulated categories. For example, as shown in FIG. 13, if an advertiser wanted a male who was either calling from one of the cities defined in the parameters of CATEGORY 3 or calling a number with a 202 area code, the equation could be IF (CATEGORY 1=YES OR CATEGORY 3=YES) AND CATEGORY 2=YES, THEN AD QUALIFIES 1310. Similarly, as shown in FIG. 14, an advertisement could require that just one of the categories be met, and the equation could be IF CATEGORY 1=YES OR CATEGORY 2=YES OR CATEGORY 3=YES, THEN AD QUALIFIES 1410.

In any case, whatever equation is used, if the criteria are met, then the advertisement qualifies and is retrieved as part of the first group of advertisements.

In determining which advertisements will be part of the second or third group of advertisements, the advertisements undergo a filtering process. In one embodiment, the filtering process occurs at the retrieving step. In an alternative embodiment, the filtering process occurs at the sending step. In yet another embodiment, the filtering process occurs at both the retrieving and sending steps. Filtering may be necessary if a group of advertisements contains multiple advertisements each meeting the criteria to be shown at a particular time or within a particular time frame or within overlapping time frames. The filtering process can occur in a number of ways known to one of skill in the art.

In one exemplary embodiment, there may be one or more “tags” attached to all advertisements that determines a “value” associated with a particular advertisement. In a preferred embodiment, the value may be associated with how much the advertiser associated with the advertisement is paying to have his advertisements displayed. In another embodiment, the additional category may be associated with the quantity of advertisements purchased by the advertiser. In another embodiment, the additional category may be associated with the amount of time that the advertiser has been advertising with the service.

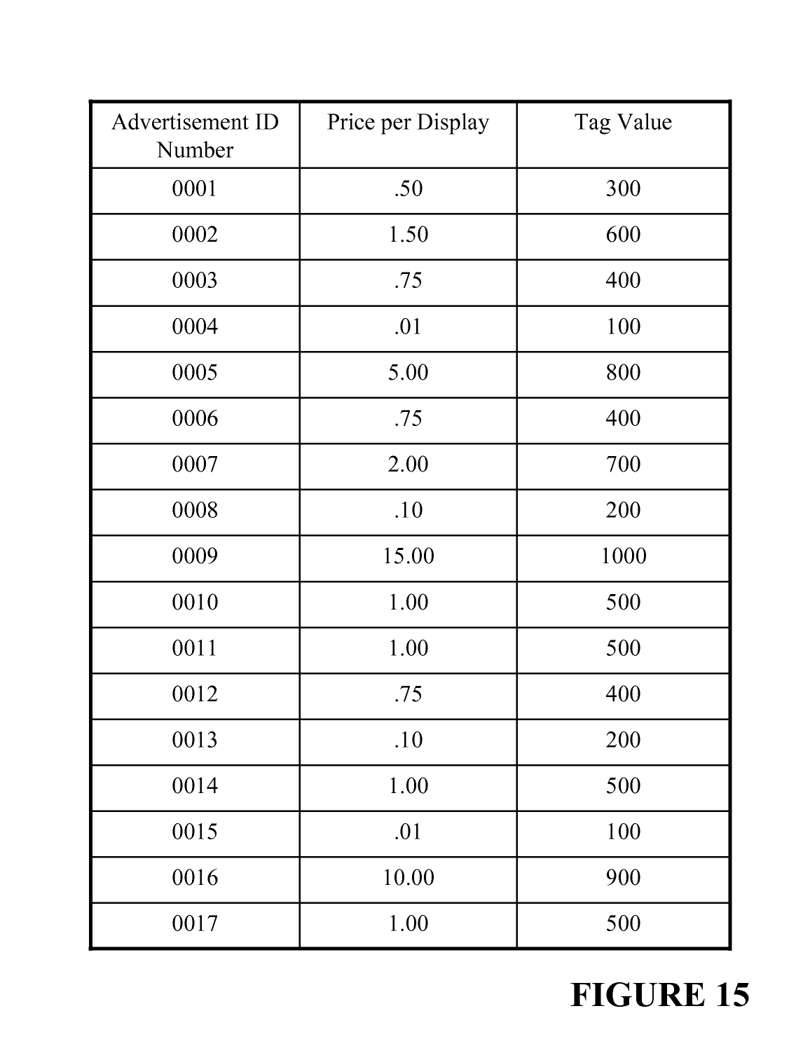

By way of example, as illustrated in FIG. 15, the tags may be numbered 100-1000 in increments of 100. The tags may represent the amount of money that an advertiser is paying to have his advertisements shown. In one embodiment, for example, advertisements that cost $0.01 per display may be given a tag value of 100; advertisements that cost $0.10 per display may be given a tag value of 200; advertisements that cost $0.50 per display may be given a tag value of 300; advertisements that cost $0.75 per display may be given a tag value of 400; advertisements that cost $1.00 per display may be given a tag value of 500; advertisements that cost $1.50 per display may be given a tag value of 600; advertisements that cost $2.00 per display may be given a tag value of 700; advertisements that cost $5.00 per display may be given a tag value of 800; advertisements that cost $10.00 per display may be given a tag value of 900; and advertisements that cost $15.00 per display may be given a tag value of 1000.

In the event that more than one advertisement is suitable to be displayed at a particular time, the tags may be used to determine which advertisement of the group is displayed. (i.e. the advertisement associated with the tag with the highest value will be displayed).

The value of a tag may be altered by an administrator. For example, using the previous example, an advertiser paying $1.00 per display may be given a tag value of 500 based on the amount he pays per advertisement shown. However, if the administrator wanted to increase the probability of a particular advertisement being displayed, the tag number associated with the advertisement could be increased, in this case, for example, to 550.

To determine which qualified advertisement should be displayed, in one embodiment, the system may also take into account the number of advertisements purchased for a particular time period. For example, in one embodiment, advertisements may be pre-purchased by a “lot” and filtering may be accomplished, at least in part, by determining which advertisements must be displayed the most times within a particular time period. In one simple example, one advertiser may request that his advertisement be shown 1000 times within the month and another advertiser may request that his advertisement be shown 5000 times within the month. In one embodiment, at the beginning of the month, if both of these advertisements are in the same group, the advertisement of the advertiser that purchased 5000 showings will be displayed because that advertiser has the most advertisements (5000) remaining for the month. Likewise, if a group of advertisements contains multiple advertisements mid way through the month, the advertiser with the most showings remaining that month will be displayed.

In alternative embodiments, other additional criteria may be used to determine which advertisement out of a group of advertisements will be selected. For example, if a particular advertisement had numerous categories, or had very narrowly defined categories, that advertisement may be selected over an advertisement with fewer or more broadly defined categories, even if the former had fewer showings remaining. For example, if a group of advertisements contained one advertisement associated with the following categories: (1) type of business associated with the phone number being dialed=jeweler; (2) age=30-40; (3) gender=male; (4) income=≧$200,000; (5) marital status=single; (6) city=Washington, D.C.; (7)≧90% calls=7 pm-11 pm; (6)≧3 calls=jewelers, and the same group of advertisements contained another advertisement associated with the following categories: (1) city=Washington, D.C.; (2) age=18-40, the advertisement for the former advertiser may be shown even if the advertisement for the latter advertiser had more showings remaining for the particular time period, because the criteria associated with the former is so specific that it is less likely that the advertisement will match a phone call related event as often as that of the latter.

Other criteria that could cause one advertisement with fewer showings remaining to be chosen over an advertisement with more showings could be, for example, restricting the showing to certain times of day, restricting the showing to only a few specific days, or limiting the number of showing of a particular advertisement per a certain time period (such as once per hour, or 5 times per day, etc.). For example, if a particular advertisement can only be shown between 7 am and 9 am, it may be selected during that time, even if another advertisement with more showings remaining also qualified (assuming the other advertisement did not have similar time restrictions or other restrictive criteria).

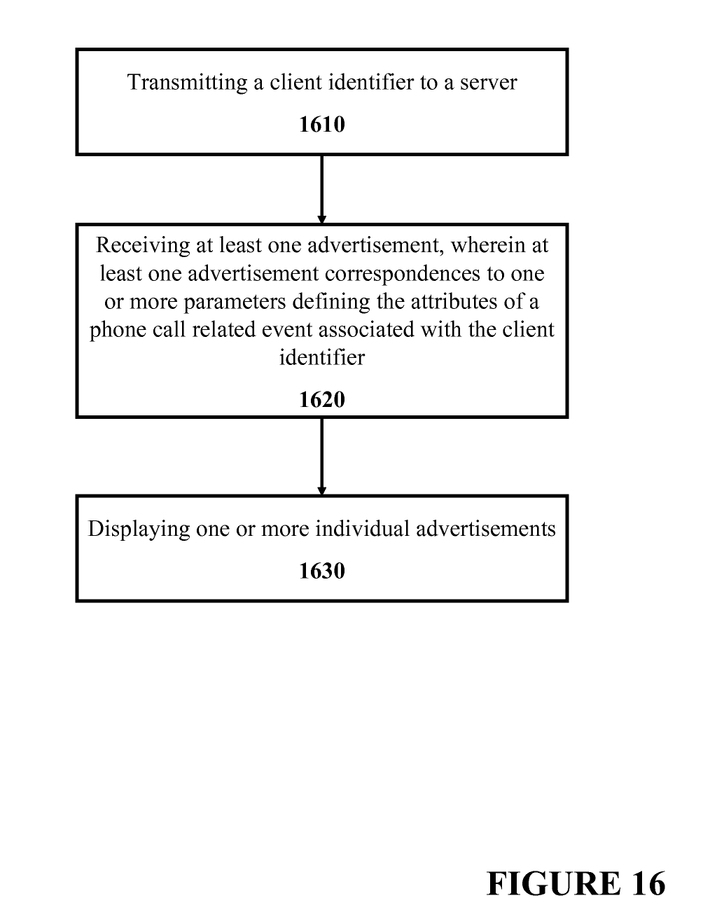

FIG. 16 illustrates a process for displaying one or more individual advertisements. In one embodiment, the process is from the perspective of a client device. The client device can be any device that alone, or in combination with another device, is capable of storing and running softphone software. Examples of possible client devices include a USB device, a DECT phone, a cellular phone, and a computer. In a preferred embodiment, the client device is a USB device. In one embodiment, the client device may comprise a first processor based device, which can be a computer. In another embodiment, the client device may be coupled to the first processor based device.

The process includes transmitting a client identifier to a server 1610. The client identifier can be any information that identifies a particular customer or client device, for example, a customer identifier, a client device serial number, a customer phone number, an Internet Protocol Address, or a media access control device. A password may also be associated with the unique client identifier. In a preferred embodiment, the unique client identifier is a client device serial number, which may or may not be coupled with a password.

The client device may be coupled to the server via at least one communications or data network, such as a packet-switched network. In a preferred embodiment, communication between the client device and the server is by HTTP and is implemented via TCP/IP protocol.

In one embodiment, the server may be adapted to provide location identifying information corresponding to the client identifier. The customer location identifying information can be any information that associates a particular customer or client device with a particular geographic area, for example, an Internet protocol address, a zip code, state, municipality, street address, latitude and longitude coordinates, global positioning system coordinates, or information defining an area based on certain market characteristics. The location identifying information may be that of the current location of the client device or the location associated with registration of the client device. Geographical data programs that provide location identifying information corresponding to a client identifier are well known to those skilled in the art and are readily available. An example of a readily available software program includes GeoCoder Object by Melissa DATA Corp. Additional sources of location identifying information may be found at opensourcegis.org (Open Source GIS), maxmind.com (GeoIP API), ofb.net/%/7Eegnor/google.html (Geocoder), and geocoder.us (Geocoder.us). In a preferred embodiment, location identifying information is latitude and longitude coordinates associated with the customer's location. In a further embodiment, demographic information, such as age, employment status, gender, income, and/or marital status, may also be associated with the unique client identifier.

The process continues by receiving at least one advertisement corresponding to one or more parameters defining the attributes of one or more phone call related events associated with the client identifier 1620.

The attributes may comprise customer proprietary network information (CPNI), such as the location of the call origination or destination, the area code of the calling or called party, the phone number exchange of the calling or called party, the phone number of the calling or called party, the time a call is made or received, the date a call is made or received, and the duration of a call. The attributes may also comprise customer proprietary network information equivalent data (CPNI equivalent data), which, as used herein, is similar information as CPNI, but the data received is not necessarily from a telecommunications company and not necessarily generated pursuant to a phone call being transmitted.

The attributes may also comprise information that may be extrapolated from the CPNI or CPNI equivalent data, such as, the category or categories of a business dialed, the name of a business dialed, the zip code, municipality, street address, latitude and longitude coordinates, global positioning system coordinates, or information defining an area based on certain market characteristics associated with the dialing number or the number dialed.

The attributes may also include compilations of data such as the average length of phone calls made and/or received, the days of the week and/or the time of day that phone calls are made and/or received, the origination or destination of phone calls, the categories of businesses frequently dialed, or any other information obtained from compiling CPNI and/or CPNI equivalent data and extrapolations from such data.

A phone call related event can be any event associated with using a phone. In a preferred embodiment, a phone call related event comprises establishing a telephone connection. In other embodiments, a phone call related event can include entering digits into a phone book or contact list, entering digits into a phone device, or entering digits into a phone device in anticipation of establishing a telephone connection.

In a further embodiment, in the case where demographic information may also be associated with the unique client identifier, the advertisements received may correspond to such demographic information associated with said client identifier in addition to parameters defining the attributes of one or more phone call related events.

The process continues by displaying one or more individual advertisements 1630. One or more individual advertisements may be displayed on any device capable of displaying an advertisement. In one embodiment, the one or more advertisements are displayed on a remote device. In one embodiment, the client device is the remote device. In another embodiment, the remote device includes the client device. In another embodiment, the remote device comprises a second processor based device. In another embodiment, the third group of advertisements is sent to a remote device via a client device. In another embodiment, the remote device comprises a client device. The client device can be any device capable of displaying or facilitating the display of advertisements, for example, a USB device, a DECT phone, a cellular phone, a computer with monitor, and a set top box, such as a cable box or satellite box, coupled to a television or video screen.

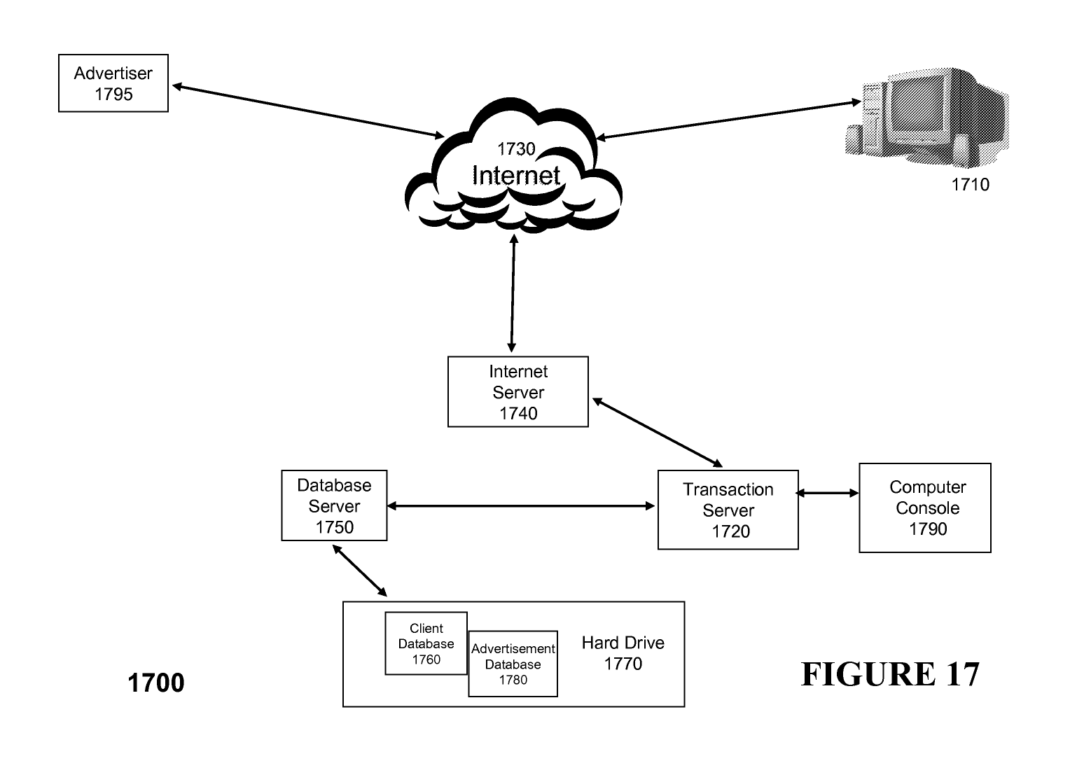

FIG. 17 depicts a network environment 1700 in which a client device 1710 of the present invention may be employed. In FIG. 17, the client device is a computer. Once the softphone is running on the client device, the client device sends a unique client identifier to a transaction server 1720 via a communications or data network, which may include a packet switched network, such as the Internet 1730, and/or an internet server 1740.

The client device 1710 connects to the transaction server 1720 via the Internet server 1740 (optional) and the network 1730 and relies on the transaction server 1720 to deliver information that is received by the client device 1710. In a preferred embodiment, the protocol used to communicate with the client device 1710 implementing the softphone is hypertext transfer protocol (“HTTP”). The HTTP instructions are sent across the network (e.g., Internet 1730) via Transmission Control Protocol/Internet Protocol (TCP/IP), which breaks the data into packets and recombines them on the receiving computer, whether client or server.

The transaction server 1720 utilizes the unique client identifier to query a database of a database server 1750. In one embodiment, the serial number is queried against a client database 1760. The data of the client database 1760 can reside on a hard drive 1770 coupled to the database server 1750, which may have one or more databases (e.g., the client database 1760 and/or advertisement database 1780) associated therewith. Alternatively, the databases may be stored on multiple hard drives, which may include hard drives presented in a Redundant Array of Inexpensive Disks (RAID) configuration. Preferably, the databases are relational databases. Whereas the client database 1760 holds information regarding attributes such as CPNI, CPNI equivalent data, and demographic information associated with the client identifier, the advertisement database 1770 holds advertisements and information relating to advertisers and advertisements.

The transaction server 1720 runs the algorithms that are described herein for determining which advertisements should be sent to the client device 1710 and also coordinates retrieving that advertising from the database server 1750 based on information relating to the client information and the advertisements. A computer console 1790 is provided so that an administrator can interact with the transaction server 1720 and/or with the database server 1750, either directly or through the transaction server 1720 (as shown), to add, delete and/or alter information in the client and advertisement databases 1760 and 1780. The administrator may receive advertisement information from an advertiser 1795 electronically over the network 1730.

We claim:

1. A process for displaying one or more individual advertisements, said process comprising:
(i) receiving a client identifier;
(ii) searching a database to identify a first group of advertisements corresponding to one or more parameters defining the attributes of a phone call related event associated with said client identifier;
(iii) retrieving a second group of advertisements, wherein said second group of advertisements is selected from said first group of advertisements; and
(iv) sending a third group of advertisements to a remote device, wherein said third group of advertisements is selected from said second group of advertisements, such that said remote device displays said one or more individual advertisements selected from said third group of advertisements.

2. The process of claim 1, wherein said step of receiving includes receiving said client identifier from a client device.

3. The process of claim 2, wherein said client device comprises at least one of a USB device, a DECT phone, a cellular phone, and a computer.

4. The process of claim 2, wherein said client device comprises said remote device.

5. The process of claim 2, wherein said remote device comprises said client device.

6. The process of claim 1, wherein said step of receiving includes receiving said client identifier from a first processor based device.

7. The process of claim 6, wherein said client device comprises said first processor based device.

8. The process of claim 6, wherein said remote device comprises a second processor based device.

9. The process of claim 1, wherein said step of receiving includes receiving said client identifier from a computer.

10. The process of claim 1 wherein said database is housed in a transaction server.

11. The process of claim 1, wherein said step of sending comprises sending a third group of advertisements to a remote device via a client device.

12. The process of claim 1, wherein said remote device comprises at least one of a client device, a USB device, a DECT phone, a cellular phone, and a computer.

13. The process of claim 1, wherein said remote device comprises a set top box coupled to at least one of a video screen and a television.

14. The process of claim 13, wherein said set top box comprises at least one of a satellite box and a cable box.

15. The process of claim 1, further comprising the step of obtaining location identifying information associated with said client identifier.

16. The process of claim 15, wherein said location identifying information comprises at least one of an Internet protocol address, a zip code, a state, a municipality, a street address, latitude and longitude coordinates, global positioning system coordinates, and information defining an area based on certain market characteristics.

17. The process of claim 16, wherein said location identifying information is the location identifying information where said client device is located at the time said location identifying information is obtained.

18. The process of claim 16, wherein said location identifying information is the location identifying information registered with said client device.

19. The process of claim 1, further comprising a step of retrieving demographic information associated with said client identifier.

20. The process of claim 19, wherein said demographic information comprises at least one of the age of a person, the employment status of a person, the gender of a person, the income of a person, the marital status of a person, and location identifying information associated with a person.

21. The process of claim 19, further comprising searching a database to identify a first group of advertisements corresponding to one or more parameters defining the attributes of a phone call related event and to demographic information associated with said client identifier.

22. The process of claim 19, wherein said second group of advertisements is selected from said first group of advertisements based on said demographic information associated with said client identifier.

23. The process of claim 19, wherein said third group of advertisements is selected from said second group of advertisements based on said demographic information associated with said client identifier.

24. The process of claim 19, wherein said one or more individual advertisements is selected from said third of advertisements based on said demographic information associated with said client identifier.

25. The process of claim 1, wherein said phone call related event comprises at least one of establishing a telephone connection, entering digits into a contact list, entering digits into a phone device, and entering digits into a phone device in anticipation of establishing a telephone connection.

26. The process of claim 1, wherein said client identifier comprises at least one of a customer identifier, a serial number associated with said client device, a password, a customer phone number, an Internet Protocol Address, and a media access control address.

27. The process of claim 1, wherein said first group of advertisements comprises all of said one or more individual advertisements corresponding to one or more parameters defining the attributes of a phone call related event associated with said client identifier.

28. The process of claim 1, where said second group of advertisements comprises all of said one or more individual advertisements corresponding to one or more parameters defining the attributes of a phone call related event associated with said client identifier.

29. The process of claim 1, where said third group of advertisements comprises all of said one or more individual advertisements corresponding to one or more parameters defining the attributes of a phone call related event associated with said client identifier.

30. The process of claim 1, where said second group of advertisements comprises the same one or more individual advertisements as said first group of advertisements.

31. The process of claim 1, where said third group of advertisements comprises the same one or more individual advertisements as said second group of advertisements.

32. The process of claim 1, where said third group of advertisements comprises the same one or more individual advertisements as said first group of advertisements.

33. The process of claim 1, where said first group of advertisements comprises one advertisement.

34. The process of claim 1, where said second group of advertisements comprises one advertisement.

35. The process of claim 1, where said third group of advertisements comprises one advertisement.

36. The process of claim 1, wherein data of said database is stored in a memory.

37. The process of claim 36, wherein data of said database is stored in a memory accessible by a second processor-based device.

38. The process of claim 36, wherein said first processor-based device is coupled via at least one communications network to a second processor-based device.

39. The process of claim 36, wherein said first processor-based device is coupled via at least one data network to a second processor-based device.

40. The process of claim 39, wherein said data network is a packet-switched network.

41. The process of claim 1, further comprising a step of determining whether said client identifier is an authorized client identifier.

42. The process of claim 38, wherein communication between said first processor-based device and said second processor-based device is by hypertext transfer protocol.

43. The process of claim 38, wherein communication between said first processor-based device and said second processor-based device is implemented via TCP/IP protocol.

44. The process of claim 1, wherein said database is a relational database.

45. The process of claim 1, wherein said attributes comprise at least one of customer proprietary network information, an area code, a phone number, a phone number exchange, one or more business categories, a business name, a zip code, a state, a municipality, latitude and longitude coordinates, global positioning system coordinates, and information defining an area based on certain market characteristics.

46. The process of claim 45, wherein said area code is the area code dialed.

47. The process of claim 45, wherein said phone number is the phone number dialed.

48. The process of claim 45, wherein said phone number exchange is the phone number exchange dialed.

49. The process of claim 1, further comprising the step of:
(v) conveying information related to said phone call related event to a third party via a network to facilitate advertisement selection.

50. The process of claim 49, wherein said third party is a cable television provider.

51. The process of claim 49, wherein said third party is a satellite television provider.

52. The process of claim 49, wherein said third party is a third party display.

53. A computer-readable medium having computer-executable instructions stored thereon for performing a method of displaying one or more individual advertisements, said method comprising:
(i) receiving a client identifier;
(ii) searching a database to identify a first group of advertisements corresponding to one or more parameters defining the attributes of a phone call related event associated with said client identifier;
(iii) retrieving a second group of advertisements, wherein said second group of advertisements is selected from said first group of advertisements; and
(iv) sending a third group of advertisements to a remote device, wherein said third group of advertisements is selected from said second group of advertisements, such that said remote device displays said one or more individual advertisements selected from said third group of advertisements.

54. The computer-readable medium of claim 53, wherein said step of receiving includes receiving said client identifier from a client device.

55. The computer-readable medium of claim 54, wherein said client device comprises at least one of a USB device, a DECT phone, a cellular phone, and a computer.

56. The computer-readable medium of claim 54, wherein said client device comprises said remote device.

57. The computer-readable medium of claim 54, wherein said remote device comprises said client device.

58. The computer-readable medium of claim 53, wherein said step of receiving includes receiving said client identifier from a first processor based device.

59. The computer-readable medium of claim 58, wherein said client device comprises said first processor based device.

60. The computer-readable medium of claim 58, wherein said remote device comprises a second processor based device.

61. The computer-readable medium of claim 53, wherein said step of receiving includes receiving said client identifier from a computer.

62. The computer-readable medium of claim 53 wherein said database is housed in a transaction server.

63. The computer-readable medium of claim 53, wherein said step of sending comprises sending a third group of advertisements to a remote device via a client device.

64. The computer-readable medium of claim 53, wherein said remote device comprises at least one of a client device, a USB device, a DECT phone, a cellular phone, and a computer.

65. The computer-readable medium of claim 53, wherein said remote device comprises a set top box coupled to at least one of a video screen and a television.

66. The computer-readable medium of claim 65, wherein said set top box comprises at least one of a satellite box and a cable box.

67. The computer-readable medium of claim 53, further comprising the step of obtaining location identifying information associated with said client identifier.

68. The computer-readable medium of claim 67, wherein said location identifying information comprises at least one of an Internet protocol address, a zip code, a state, a municipality, a street address, latitude and longitude coordinates, global positioning system coordinates, and information defining an area based on certain market characteristics.

69. The computer-readable medium of claim 68, wherein said location identifying information is the location identifying information where said client device is located at the time said location identifying information is obtained.

70. The computer-readable medium of claim 68, wherein said location identifying information is the location identifying information registered with said client device.

71. The computer-readable medium of claim 53, further comprising a step of retrieving demographic information associated with said client identifier.

72. The computer-readable medium of claim 71, wherein said demographic information comprises at least one of the age of a person, the employment status of a person, the gender of a person, the income of a person, the marital status of a person, and location identifying information associated with a person.

73. The computer-readable medium of claim 71, further comprising searching a database to identify a first group of advertisements corresponding to one or more parameters defining the attributes of a phone call related event and to demographic information associated with said client identifier.

74. The computer-readable medium of claim 71, wherein said second group of advertisements is selected from said first group of advertisements based on said demographic information associated with said client identifier.

75. The computer-readable medium of claim 71, wherein said third group of advertisements is selected from said second group of advertisements based on said demographic information associated with said client identifier.

76. The computer-readable medium of claim 71, wherein said one or more individual advertisements is selected from said third of advertisements based on said demographic information associated with said client identifier.

77. The computer-readable medium of claim 53, wherein said phone call related event comprises at least one of establishing a telephone connection, entering digits into a contact list, entering digits into a phone device, and entering digits into a phone device in anticipation of establishing a telephone connection.

78. The computer-readable medium of claim 53, wherein said client identifier comprises at least one of a customer identifier, a serial number associated with said client device, a password, a customer phone number, an Internet Protocol Address, and a media access control address.

79. The computer-readable medium of claim 53, wherein said first group of advertisements comprises all of said one or more individual advertisements corresponding to one or more parameters defining the attributes of a phone call related event associated with said client identifier.

80. The computer-readable medium of claim 53, where said second group of advertisements comprises all of said one or more individual advertisements corresponding to one or more parameters defining the attributes of a phone call related event associated with said client identifier.

81. The computer-readable medium of claim 53, where said third group of advertisements comprises all of said one or more individual advertisements corresponding to one or more parameters defining the attributes of a phone call related event associated with said client identifier.

82. The computer-readable medium of claim 53, where said second group of advertisements comprises the same one or more individual advertisements as said first group of advertisements.

83. The computer-readable medium of claim 53, where said third group of advertisements comprises the same one or more individual advertisements as said second group of advertisements.

84. The computer-readable medium of claim 53, where said third group of advertisements comprises the same one or more individual advertisements as said first group of advertisements.

85. The computer-readable medium of claim 53, where said first group of advertisements comprises one advertisement.

86. The computer-readable medium of claim 53, where said second group of advertisements comprises one advertisement.

87. The computer-readable medium of claim 53, where said third group of advertisements comprises one advertisement.

88. The computer-readable medium of claim 53, wherein data of said database is stored in a memory.

89. The computer-readable medium of claim 88, wherein data of said database is stored in a memory accessible by a second processor-based device.

90. The computer-readable medium of claim 88, wherein said first processor-based device is coupled via at least one communications network to a second processor-based device.

91. The computer-readable medium of claim 88, wherein said first processor-based device is coupled via at least one data network to a second processor-based device.

92. The computer-readable medium of claim 91, wherein said data network is a packet-switched network.

93. The computer-readable medium of claim 53, further comprising a step of determining whether said client identifier is an authorized client identifier.

94. The computer-readable medium of claim 90, wherein communication between said first processor-based device and said second processor-based device is by hypertext transfer protocol.

95. The computer-readable medium of claim 90, wherein communication between said first processor-based device and said second processor-based device is implemented via TCP/IP protocol.

96. The computer-readable medium of claim 53, wherein said database is a relational database.

97. The computer-readable medium of claim 53, wherein said attributes comprise at least one of customer proprietary network information, an area code, a phone number, a phone number exchange, one or more business categories, a business name, a zip code, a state, a municipality, latitude and longitude coordinates, global positioning system coordinates, and information defining an area based on certain market characteristics.

98. The computer-readable medium of claim 97, wherein said area code is the area code dialed.

99. The computer-readable medium of claim 97, wherein said phone number is the phone number dialed.

100. The computer-readable medium of claim 97, wherein said phone number exchange is the phone number exchange dialed.

101. The computer-readable medium of claim 53, further comprising the step of:
(v) conveying information related to said phone call related event to a third party via a network to facilitate advertisement selection.

102. The computer-readable medium of claim 101, wherein said third party is a cable television provider.

103. The computer-readable medium of claim 101, wherein said third party is a satellite television provider.

104. The computer-readable medium of claim 101, wherein said third party is a third party display.

105. A process for displaying one or more individual advertisements, said process comprising:
(i) receiving a client identifier;
(ii) searching a database to identify a group of one or more advertisements corresponding to one or more parameters defining the attributes of a phone call related event associated with said client identifier;
(iii) retrieving said group of one or more advertisements from said database; and
(iv) sending said group of one or more advertisements to a remote device, wherein said remote device displays said one or more individual advertisements selected from said group.

106. The process of claim 105, wherein said step of receiving includes receiving said client identifier from a client device.

107. The process of claim 106, wherein said client device comprises at least one of a USB device, a DECT phone, a cellular phone, and a computer.

108. The process of claim 106, wherein said client device comprises said remote device.

109. The process of claim 106, wherein said remote device comprises said client device.

110. The process of claim 105, wherein said step of receiving includes receiving said client identifier from a first processor based device.

111. The process of claim 110, wherein said client device comprises said first processor based device.

112. The process of claim 110, wherein said remote device comprises a second processor based device.

113. The process of claim 105, wherein said step of receiving includes receiving said client identifier from a computer.

114. The process of claim 105, wherein said database is housed in a transaction server.

115. The process of claim 105, wherein said step of sending comprises sending said group of advertisements to a remote device via a client device.

116. The process of claim 105, wherein said remote device comprises at least one of a client device, a USB device, a DECT phone, a cellular phone, and a computer.

117. The process of claim 105, wherein said remote device comprises a set top box coupled to at least one of a video screen and a television.

118. The process of claim 117, wherein said set top box comprises at least one of a satellite box and a cable box.

119. The process of claim 105, further comprising the step of obtaining location identifying information associated with said client identifier.

120. The process of claim 119, wherein said location identifying information comprises at least one of an Internet protocol address, a zip code, a state, a municipality, a street address, latitude and longitude coordinates, global positioning system coordinates, and information defining an area based on certain market characteristics.

121. The process of claim 120, wherein said location identifying information is the location identifying information where said client device is located at the time said location identifying information is obtained.

122. The process of claim 120, wherein said location identifying information is the location identifying information registered with said client device.

123. The process of claim 105, further comprising a step of retrieving demographic information associated with said client identifier.

124. The process of claim 123, wherein said demographic information comprises at least one of the age of a person, the employment status of a person, the gender of a person, the income of a person, the marital status of a person, and location identifying information associated with a person.

125. The process of claim 123, further comprising searching a database to identify a group of advertisements corresponding to one or more parameters defining the attributes of a phone call related event and to demographic information associated with said client identifier.

126. The process of claim 105, wherein said phone call related event comprises at least one of establishing a telephone connection, entering digits into a contact list, entering digits into a phone device, and entering digits into a phone device in anticipation of establishing a telephone connection.

127. The process of claim 105, wherein said client identifier comprises at least one of a customer identifier, a serial number associated with said client device, a password, a customer phone number, an Internet Protocol Address, and a media access control address.

128. The process of claim 105, wherein said group of one or more advertisements comprises all of said one or more individual advertisements corresponding to one or more parameters defining the attributes of a phone call related event associated with said client identifier.

129. The process of claim 105, where said group of one or more advertisements comprises one advertisement.

130. The process of claim 105, wherein data of said database is stored in a memory.

131. The process of claim 130, wherein data of said database is stored in a memory accessible by a second processor-based device.

132. The process of claim 130, wherein said first processor-based device is coupled via at least one communications network to a second processor-based device.

133. The process of claim 130, wherein said first processor-based device is coupled via at least one data network to a second processor-based device.

134. The process of claim 133, wherein said data network is a packet-switched network.

135. The process of claim 105, further comprising a step of determining whether said client identifier is an authorized client identifier.

136. The process of claim 132, wherein communication between said first processor-based device and said second processor-based device is by hypertext transfer protocol.

137. The process of claim 132, wherein communication between said first processor-based device and said second processor-based device is implemented via TCP/IP protocol.

138. The process of claim 105, wherein said database is a relational database.

139. The process of claim 105, wherein said attributes comprise at least one of customer proprietary network information, an area code, a phone number, a phone number exchange, one or more business categories, a business name, a zip code, a state, a municipality, latitude and longitude coordinates, global positioning system coordinates, and information defining an area based on certain market characteristics.

140. The process of claim 139, wherein said area code is the area code dialed.

141. The process of claim 139, wherein said phone number is the phone number dialed.

142. The process of claim 139, wherein said phone number exchange is the phone number exchange dialed.

143. The process of claim 105, further comprising the step of:
(v) conveying information related to said phone call related event to a third party via a network to facilitate advertisement selection.

144. The process of claim 143, wherein said third party is a cable television provider.

145. The process of claim 143, wherein said third party is a satellite television provider.

146. The process of claim 143, wherein said third party is a third party display.

147. A computer-readable medium having computer-executable instructions stored thereon for performing a method of displaying one or more individual advertisements, said method comprising:
(i) receiving a client identifier;
(ii) searching a database to identify a group of one or more advertisements corresponding to one or more parameters defining the attributes of a phone call related event associated with said client identifier;
(iii) retrieving said group of one or more advertisements from said database; and
(iv) sending said group of one or more advertisements to a remote device, wherein said remote device displays said one or more individual advertisements selected from said group.

148. The computer-readable medium of claim 147, wherein said step of receiving includes receiving said client identifier from a client device.

149. The computer-readable medium of claim 148, wherein said client device comprises at least one of a USB device, a DECT phone, a cellular phone, and a computer.

150. The computer-readable medium of claim 148, wherein said client device comprises said remote device.

151. The computer-readable medium of claim 148, wherein said remote device comprises said client device.

152. The computer-readable medium of claim 147, wherein said step of receiving includes receiving said client identifier from a first processor based device.

153. The computer-readable medium of claim 152, wherein said client device comprises said first processor based device.

154. The computer-readable medium of claim 152, wherein said remote device comprises a second processor based device.

155. The computer-readable medium of claim 147, wherein said step of receiving includes receiving said client identifier from a computer.

156. The computer-readable medium of claim 147, wherein said database is housed in a transaction server.

157. The computer-readable medium of claim 147, wherein said step of sending comprises sending said group of advertisements to a remote device via a client device.

158. The computer-readable medium of claim 147, wherein said remote device comprises at least one of a client device, a USB device, a DECT phone, a cellular phone, and a computer.

159. The computer-readable medium of claim 147, wherein said remote device comprises a set top box coupled to at least one of a video screen and a television.

160. The computer-readable medium of claim 159, wherein said set top box comprises at least one of a satellite box and a cable box.

161. The computer-readable medium of claim 147, further comprising the step of obtaining location identifying information associated with said client identifier.

162. The computer-readable medium of claim 161, wherein said location identifying information comprises at least one of an Internet protocol address, a zip code, a state, a municipality, a street address, latitude and longitude coordinates, global positioning system coordinates, and information defining an area based on certain market characteristics.

163. The computer-readable medium of claim 162, wherein said location identifying information is the location identifying information where said client device is located at the time said location identifying information is obtained.

164. The computer-readable medium of claim 162, wherein said location identifying information is the location identifying information registered with said client device.

165. The computer-readable medium of claim 147, further comprising a step of retrieving demographic information associated with said client identifier.

166. The computer-readable medium of claim 165, wherein said demographic information comprises at least one of the age of a person, the employment status of a person, the gender of a person, the income of a person, the marital status of a person, and location identifying information associated with a person.

167. The computer-readable medium of claim 165, further comprising searching a database to identify a group of advertisements corresponding to one or more parameters defining the attributes of a phone call related event and to demographic information associated with said client identifier.

168. The computer-readable medium of claim 147, wherein said phone call related event comprises at least one of establishing a telephone connection, entering digits into a contact list, entering digits into a phone device, and entering digits into a phone device in anticipation of establishing a telephone connection.

169. The computer-readable medium of claim 147, wherein said client identifier comprises at least one of a customer identifier, a serial number associated with said client device, a password, a customer phone number, an Internet Protocol Address, and a media access control address.

170. The computer-readable medium of claim 147, wherein said group of one or more advertisements comprises all of said one or more individual advertisements corresponding to one or more parameters defining the attributes of a phone call related event associated with said client identifier.

171. The computer-readable medium of claim 147, where said group of one or more advertisements comprises one advertisement.

172. The computer-readable medium of claim 147, wherein data of said database is stored in a memory.

173. The computer-readable medium of claim 172, wherein data of said database is stored in a memory accessible by a second processor-based device.

174. The computer-readable medium of claim 172, wherein said first processor-based device is coupled via at least one communications network to a second processor-based device.

175. The computer-readable medium of claim 172, wherein said first processor-based device is coupled via at least one data network to a second processor-based device.

176. The computer-readable medium of claim 175, wherein said data network is a packet-switched network.

177. The computer-readable medium of claim 147, further comprising a step of determining whether said client identifier is an authorized client identifier.

178. The process of claim 174, wherein communication between said first processor-based device and said second processor-based device is by hypertext transfer protocol.

179. The computer-readable medium of claim 174, wherein communication between said first processor-based device and said second processor-based device is implemented via TCP/IP protocol.

180. The computer-readable medium of claim 147, wherein said database is a relational database.

181. The computer-readable medium of claim 147, wherein said attributes comprise at least one of customer proprietary network information, an area code, a phone number, a phone number exchange, one or more business categories, a business name, a zip code, a state, a municipality, latitude and longitude coordinates, global positioning system coordinates, and information defining an area based on certain market characteristics.

182. The computer-readable medium of claim 181, wherein said area code is the area code dialed.

183. The computer-readable medium of claim 181, wherein said phone number is the phone number dialed.

184. The computer-readable medium of claim 181, wherein said phone number exchange is the phone number exchange dialed.

185. The computer-readable medium of claim 147, further comprising the step of:
(v) conveying information related to said phone call related event to a third party via a network to facilitate advertisement selection.

186. The computer-readable medium of claim 185, wherein said third party is a cable television provider.

187. The computer-readable medium of claim 185, wherein said third party is a satellite television provider.

188. The computer-readable medium of claim 185, wherein said third party is a third party display.

189. A process for displaying one or more individual advertisements, said process comprising:
(i) transmitting a client identifier to a server; and
(ii) receiving at least one advertisement, wherein said at least one advertisement corresponds to one or more parameters defining the attributes of a phone call related event associated with said client identifier.

190. The process of claim 189, wherein said step of transmitting includes transmitting said client identifier from a client device.

191. The process of claim 190, wherein said client device comprises at least one of a USB device, a DECT phone, a cellular phone, and a computer.

192. The process of claim 190, wherein said client device comprises said remote device.

193. The process of claim 190, wherein said remote device comprises said client device.

194. The process of claim 189, wherein said step of transmitting includes transmitting said client identifier from a first processor based device.

195. The process of claim 194, wherein said client device comprises said first processor based device.

196. The process of claim 194, wherein said remote device comprises a second processor based device.

197. The process of claim 189, wherein said step of transmitting includes transmitting said client identifier from a computer.

198. The process of claim 189, further comprising the step of sending at least one advertisement to a remote device.

199. The process of claim 189, wherein said remote device comprises at least one of a client device, a USB device, a DECT phone, a cellular phone, and a computer.

200. The process of claim 189, wherein said remote device comprises a set top box coupled to at least one of a video screen and a television.

201. The process of claim 200, wherein said set top box comprises at least one of a satellite box and a cable box.

202. The process of claim 189, further comprising the step of sending location identifying information associated with said client identifier.

203. The process of claim 202, wherein said location identifying information comprises at least one of an Internet protocol address, a zip code, a state, a municipality, a street address, latitude and longitude coordinates, global positioning system coordinates, and information defining an area based on certain market characteristics.

204. The process of claim 203, wherein said location identifying information is the location identifying information where said client device is located at the time said location identifying information is sent.

205. The process of claim 203, wherein said location identifying information is the location identifying information registered with said client device.

206. The process of claim 189, further comprising a step of sending demographic information associated with said client identifier.

207. The process of claim 206, wherein said demographic information comprises at least one of the age of a person, the employment status of a person, the gender of a person, the income of a person, the marital status of a person, and location identifying information associated with a person.

208. The process of claim 189, wherein said phone call related event comprises at least one of establishing a telephone connection, entering digits into a contact list, entering digits into a phone device, and entering digits into a phone device in anticipation of establishing a telephone connection.

209. The process of claim 189, wherein said client identifier comprises at least one of a customer identifier, a serial number associated with said client device, a password, a customer phone number, an Internet Protocol Address, and a media access control address.

210. The process of claim 189, further comprising a step of obtaining notification that said client identifier is an authorized client identifier.

211. The process of claim 189, wherein said attributes comprise at least one of customer proprietary network information, an area code, a phone number, a phone number exchange, one or more business categories, a business name, a zip code, a state, a municipality, latitude and longitude coordinates, global positioning system coordinates, and information defining an area based on certain market characteristics.

212. The process of claim 211, wherein said area code is the area code dialed.

213. The process of claim 211, wherein said phone number is the phone number dialed.

214. The process of claim 211, wherein said phone number exchange is the phone number exchange dialed.

215. A computer-readable medium having computer-executable instructions stored thereon for performing a method of displaying one or more individual advertisements, said method comprising:
(i) transmitting a client identifier to a server; and
(ii) receiving at least one advertisement, wherein said at least one advertisement corresponds to one or more parameters defining the attributes of a phone call related event associated with said client identifier.

216. The computer-readable medium of claim 215, wherein said step of transmitting includes transmitting said client identifier from a client device.

217. The computer-readable medium of claim 216, wherein said client device comprises at least one of a USB device, a DECT phone, a cellular phone, and a computer.

218. The computer-readable medium of claim 216, wherein said client device comprises said remote device.

219. The computer-readable medium of claim 216, wherein said remote device comprises said client device.

220. The computer-readable medium of claim 215, wherein said step of transmitting includes transmitting said client identifier from a first processor based device.

221. The computer-readable medium of claim 220, wherein said client device comprises said first processor based device.

222. The computer-readable medium of claim 220, wherein said remote device comprises a second processor based device.

223. The computer-readable medium of claim 215, wherein said step of transmitting includes transmitting said client identifier from a computer.

224. The computer-readable medium of claim 215, further comprising the step of sending at least one advertisement to a remote device.

225. The computer-readable medium of claim 215, wherein said remote device comprises at least one of a client device, a USB device, a DECT phone, a cellular phone, and a computer.

226. The computer-readable medium of claim 215, wherein said remote device comprises a set top box coupled to at least one of a video screen and a television.

227. The computer-readable medium of claim 226, wherein said set top box comprises at least one of a satellite box and a cable box.

228. The computer-readable medium of claim 215, further comprising the step of sending location identifying information associated with said client identifier.

229. The computer-readable medium of claim 228, wherein said location identifying information comprises at least one of an Internet protocol address, a zip code, a state, a municipality, a street address, latitude and longitude coordinates, global positioning system coordinates, and information defining an area based on certain market characteristics.

230. The computer-readable medium of claim 229, wherein said location identifying information is the location identifying information where said client device is located at the time said location identifying information is sent.

231. The computer-readable medium of claim 229, wherein said location identifying information is the location identifying information registered with said client device.

232. The computer-readable medium of claim 215, further comprising a step of sending demographic information associated with said client identifier.

233. The computer-readable medium of claim 232, wherein said demographic information comprises at least one of the age of a person, the employment status of a person, the gender of a person, the income of a person, the marital status of a person, and location identifying information associated with a person.

234. The computer-readable medium of claim 215, wherein said phone call related event comprises at least one of establishing a telephone connection, entering digits into a contact list, entering digits into a phone device, and entering digits into a phone device in anticipation of establishing a telephone connection.

235. The computer-readable medium of claim 215, wherein said client identifier comprises at least one of a customer identifier, a serial number associated with said client device, a password, a customer phone number, an Internet Protocol Address, and a media access control address.

236. The computer-readable medium of claim 215, further comprising a step of obtaining notification that said client identifier is an authorized client identifier.

237. The computer-readable medium of claim 215, wherein said attributes comprise at least one of customer proprietary network information, an area code, a phone number, a phone number exchange, one or more business categories, a business name, a zip code, a state, a municipality, latitude and longitude coordinates, global positioning system coordinates, and information defining an area based on certain market characteristics.

238. The computer-readable medium of claim 237, wherein said area code is the area code dialed.

239. The computer-readable medium of claim 237, wherein said phone number is the phone number dialed.

240. The computer-readable medium of claim 237, wherein said phone number exchange is the phone number exchange dialed.

241. A first device capable of receiving one or more individual advertisements to display, said first device comprising:
a processor component configured to control the transmission of a client identifier to a server that identifies advertisements corresponding to one or more parameters defining the attributes of a phone call related event associated with said client identifier;
said processor component receiving a first group of advertisements and sending a second group of advertisements to a display device,
wherein said second group of advertisements is selected from said first group of advertisement.

242. A system for displaying one or more individual advertisements comprising:
a database containing a pool of advertisements; and
a processor based device having a memory, said memory storing data of said database, wherein said processor-based device is configured to conduct a search of said database to identify a first group of advertisements corresponding to one or more parameters defining the attributes of a phone call related event associated with a client identifier; retrieve a second group of advertisements from said database, wherein said second group of advertisements is selected from said first group of advertisements, and then send a third group of advertisements to a remote device, wherein said third group of advertisements is selected from said second group of advertisements, such that said remote device displays said one or more individual advertisements selected from said second group of advertisements.
